(19) United States
(12) Patent Application Publication
(10) Pub. No.: US 2025/0316706 A1
(43) Pub. Date: Oct. 9, 2025

(54) ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Toshihiro KAMADA, Kanagawa (JP); Ikuo KINOSHITA, Kanagawa (JP)

(73) Assignee: FUJIFILM Corporation, Tokyo (JP)

(21) Appl. No.: 19/246,698

(22) Filed: Jun. 24, 2025

Related U.S. Application Data
(63) Continuation of application No. PCT/JP2023/046717, filed on Dec. 26, 2023.

(30) Foreign Application Priority Data
Dec. 27, 2022 (JP) 2022-210759

(51) Int. Cl. H01M 4/62; H01M 4/131; H01M 10/0525

(52) U.S. Cl. CPC H01M 4/628; H01M 4/131; H01M 4/622; H01M 10/0525

(57) ABSTRACT

An electrode sheet for an all-solid state secondary battery, including: an active material layer on at least one surface of a collector, in which the active material layer has an inorganic solid electrolyte (A) having an ion conductivity of a metal belonging to Group 1 or Group 2 in the periodic table and an active material (B), and the active material layer satisfies Expression (1) and Expression (2), the all-solid state secondary battery having the electrode sheet as at least one electrode.

$$\begin{matrix}1.4 < S 1 / S 100 , & Expression ( 1 ) \\ 0.05 < S 1 < 0.60 & Expression ( 2 )\end{matrix}$$

S1 represents an area ratio of a total area of a material containing a carbon atom in a cross-sectional region having a layer thickness of 1% or less of the active material layer from the surface of the collector, and S100 represents an area ratio of a total area of the material containing a carbon atom in a cross-sectional region having a layer thickness of more than 1% of the active material layer from the surface of the collector.

### CROSS-REFERENCE TO RELATED APPLICATIONS

This application is a Continuation of PCT International Application No. PCT/JP2023/046717 filed on Dec. 26, 2023, which claims priority under 35 U.S.C. § 119 (a) to Japanese Patent Application No. 2022-210759 filed in Japan on Dec. 27, 2022. Each of the above applications is hereby expressly incorporated by reference, in its entirety, into the present application.

### BACKGROUND OF THE INVENTION

### 1. Field of the Invention

The present invention relates to an electrode sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary battery can greatly improve safety and reliability, which are said to be problems of a battery in which an organic electrolytic solution is used. In addition, it is also said to be capable of extending the battery life. Further, the all-solid state secondary battery can be provided with a structure in which the electrodes and the electrolyte are directly disposed in series. As a result, it is possible to increase the energy density to be high as compared with a secondary battery in which an organic electrolytic solution is used, and the application to electric vehicles, large-sized storage batteries, and the like is expected.

In an all-solid state secondary battery, an active material layer (may also be referred to as an electrode active material layer) that is laminated on a collector is typically formed of solid particles such as an inorganic solid electrolyte, an active material, and a conductive auxiliary agent. In the active material layer formed of such solid particles, since the adhesive force between the solid particles in the active material layer (may be referred to as particle adhesive force) and the interlayer adhesive force between the active material layer and the collector are not sufficient, a polymer binder is typically used in combination to strengthen the particle adhesive force and the interlayer adhesive force.

As a technique for improving the particle adhesive force, the interlayer adhesive force, and the like by using a polymer binder, for example, WO2019-230592A discloses “an electrode having an electrode active material layer containing a solid electrolyte, on a surface on which an easy adhesion layer is provided” in “a collector with an easy adhesion layer, having an easy adhesion layer that is provided on at least one surface of a collector, where the easy adhesion layer contains a polymer having a solubility of 1 g/100 g or higher in toluene at 25° C.”. In addition, JP2018-125260A discloses “an all-solid state battery comprising a positive electrode layer that comprises a positive electrode collector and a positive electrode mixture layer formed on the positive electrode collector and containing at least a positive electrode active material and a binder, a negative electrode layer that comprises a negative electrode collector and a negative electrode mixture layer formed on the negative electrode collector and containing at least a negative electrode active material and a binder, and a solid electrolyte layer that is disposed between the positive electrode mixture layer and the negative electrode mixture layer and contains at least a solid electrolyte having ion conductivity, in which a concentration of a solvent contained in at least one layer selected from the group consisting of the positive electrode mixture layer, the negative electrode mixture layer, and the solid electrolyte layer is 50 ppm or lower, and a concentration of the binder contained in at least one layer selected from the positive electrode mixture layer and the negative electrode mixture layer is higher in a vicinity of the positive electrode collector or the negative electrode collector than in a vicinity of the solid electrolyte layer”.

### SUMMARY OF THE INVENTION

Incidentally, an all-solid state secondary battery and an electrode (including an electrode sheet as a precursor of an electrode) to be incorporated into the all-solid state secondary battery may be subjected to repeated vibration due to transportation during manufacturing, transportation after manufacturing, or the like. Therefore, even in a case where the particle adhesive force and the interlayer adhesive force are increased by using a polymer binder in combination, the initial strong particle adhesive force and interlayer adhesive force cannot be maintained due to repeated vibration, and the initial adhesion state gradually collapses, causing a deterioration in the performance of the electrode and the all-solid state secondary battery.

In particular, in recent years, an industrial manufacturing method in which productivity is increased for actual manufacturing of an all-solid state secondary battery, for example, manufacturing by a roll-to-roll method in which manufacturing is performed while being transported by a plurality of rolls has been studied, and in such an industrial manufacturing method, the all-solid state secondary battery and the electrode are repeatedly subjected to large vibration during the manufacturing process, and thus there is a concern about a significant deterioration in the performance.

However, in the related art, the deterioration in the performance due to such repeated vibration has not been focused on, and has not been studied in WO2019-230592A and JP2018-125260A.

An object of the present invention is to provide an electrode sheet for an all-solid state secondary battery and an all-solid state secondary battery capable of suppressing the deterioration in the performance even in a case of being subjected to repeated vibration.

As a result of repeating various studies, the present inventors have found that, in a case of assuming that a virtual divided active material layer having 100 layers is obtained by dividing the active material layer provided on the surface of the collector into 100 equal parts in a thickness direction, and a first virtual divided active material layer to a one hundredth virtual divided active material layer are arranged in order from a collector side, by disposing the material containing a carbon atom, the inorganic solid electrolyte, and the active material in the active material layer such that an area ratio S1 of the material containing a carbon atom in the first virtual divided active material layer and an area ratio S100 of the material containing a carbon atom in an entire 99 layers from a second virtual divided active material layer to the one hundredth virtual divided active material layer satisfy Expression (1) and Expression (2) described later at the same time, the particle adhesive force in the active material layer (including the particle adhesive force in each of the virtual divided active material layers and the particle adhesive force (also referred to as the interface adhesive force) at the interface between the first virtual divided active material layer and the second virtual divided active material layer) and the interlayer adhesive force between the collector and the active material layer can be strengthened to strong adhesive forces that can suppress the collapse of the adhesion state even in a case of being subjected to repeated vibration, and the deterioration in the performance of the electrode and the all-solid state secondary battery can be suppressed. The present invention has been completed through further repeating studies based on these findings.

That is, the above problems have been solved by the following means.
<1>An electrode sheet for an all-solid state secondary battery, including:
an active material layer on at least one surface of a collector,
in which the active material layer has an inorganic solid electrolyte (A) having an ion conductivity of a metal belonging to Group 1 or Group 2 in the periodic table and an active material (B), and the active material layer satisfies Expression (1) and Expression (2).

$$\begin{matrix}1.4 < S 1 / S 100 & Expression ( 1 ) \\ 0.05 < S 1 < 0.60 & Expression ( 2 )\end{matrix}$$

In the above expressions, S1 represents an area ratio of a total area of a material containing a carbon atom with respect to an entire area of a cross-sectional region having a layer thickness of 1% or less of the active material layer from the surface of the collector, and

S100 represents an area ratio of a total area of the material containing a carbon atom with respect to an entire area of a cross-sectional region having a layer thickness of more than 1% of the active material layer from the surface of the collector.
<2>The electrode sheet for an all-solid state secondary battery according to <1>,
in which the active material layer satisfies Expression (4).

$$0.010 < ( S 1 / S 100 ) / L < 0.100 \qquad Expression ( 4 )$$

In Expression (4), L represents a layer thickness of the active material layer, and S1 and S100 are as described above.
<3>The electrode sheet for an all-solid state secondary battery according to <1>or <2>,
in which the active material layer contains a polymer binder (C) and a conductive auxiliary agent (D), and
the material containing a carbon atom contains the polymer binder (C) and the conductive auxiliary agent (D).
<4>The electrode sheet for an all-solid state secondary battery according to <3>,
in which the polymer binder (C) includes two or more kinds of polymer binders.
<5>The electrode sheet for an all-solid state secondary battery according to <4>,
in which at least one of the two or more kinds of polymer binders is a polymer binder consisting of a rubber-like polymer.
<6>The electrode sheet for an all-solid state secondary battery according to any one of <1>to <5>,
in which the active material layer satisfies Expression (3).

$$0.005 < S 100 < 0.30 \qquad Expression ( 3 )$$

In Expression (3), S100 is as described above.
<7>The electrode sheet for an all-solid state secondary battery according to any one of <1>to <6>,
in which a rate of change in an electron conductivity o2 after the following vibration test with respect to an electron conductivity o1 before the following vibration test: (1−σ2/σ1)×100 is less than 50%.

### Vibration Test

Two disk-shaped sheets having a diameter of 10 mm are punched out from the electrode sheet, the active material layers of the disk-shaped sheets are laminated to face each other, the laminate is pressurized by applying a pressure of 350 MPa in a lamination direction, and the laminate is restrained by a round bar made of STAINLESS STEEL having a diameter of 10 mm at 50 MPa in a thickness direction to produce a measurement cell.

This measurement cell is set in a vibration tester such that an electrode lamination surface and a vibration direction (vibration surface) are parallel to each other, and a vibration test is performed under the conditions of stage 30, a vibration frequency of 33 Hz, and a vibration acceleration of 30 m/s2 as conditions in accordance with Japanese Industrial Standards D 1601.

A voltage of 5 mV is applied to the measurement cell before and after the vibration test in a constant-temperature tank at 30° C. and a direct current resistance is measured to calculate each of the electron conductivity σ1 before the vibration test and the electron conductivity σ2 after the vibration test.
<8>An all-solid state secondary battery including:
a positive electrode;
a negative electrode; and
a solid electrolyte layer between the positive electrode and the negative electrode,
in which at least one of the positive electrode or the negative electrode is composed of the electrode sheet for an all-solid state secondary battery according to any one of <1>to <7>.

In the electrode sheet for an all-solid state secondary battery according to the embodiment of the present invention, the particle adhesive force in the active material layer and the interlayer adhesive force between the collector and the active material layer are strengthened, and the deterioration in the performance, for example, the electron conductivity, can be suppressed even in a case of being subjected to repeated vibration. Similarly, in the all-solid state secondary battery according to the embodiment of the present invention, the particle adhesive force in the active material layer and the interlayer adhesive force between the collector and the active material layer are strengthened, the deterioration in the battery performance can be suppressed even in a case of being subjected to repeated vibration, and for example, excellent cycle characteristics are exhibited.

The above-described and other characteristics and advantages of the present invention will be further clarified by the following description with appropriate reference to the accompanying drawing.

### BRIEF DESCRIPTION OF THE DRAWINGS

FIG. 1 is a longitudinal cross-sectional view schematically showing an electrode sheet for an all-solid state secondary battery according to a preferred embodiment of the present invention.

FIG. 2 is a longitudinal cross-sectional view schematically showing an all-solid state secondary battery according to a preferred embodiment of the present invention.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. In a case where a plurality of numerical ranges represented by “to” are set and described, the upper limit value and the lower limit value which form each of the numerical ranges are not limited to a specific combination described before and after “to” as a specific numerical range and can be set to a numerical range obtained by appropriately combining the upper limit value and the lower limit value of each numerical range. In the present invention, numerical ranges represented by “to” means a range including numerical values before and after “to” as lower limit values and upper limit values.

In the present invention, the expression of a compound (for example, in a case where a compound is represented by an expression with “compound” attached to the end) means not only the compound itself but also a salt or an ion thereof. In addition, this expression has a meaning including a derivative obtained by modifying a part of the compound, for example, by introducing a substituent into the compound within a range where the effect of the present invention is not impaired.

In the present invention, the polymer means a polymer, and it is synonymous with a so-called polymeric compound. The polymer includes a homopolymer and a copolymer, and the copolymer includes an addition polymer, a condensation polymer, and the like. A polymerization mode of the constitutional component in the copolymer is not particularly limited and may be random, block, or the like. The polymer may be a crosslinked polymer or a non-crosslinked polymer.

In the present invention, the main chain of each of the polymer and the polymerized chain refers to a linear molecular chain in which all the molecular chains that constitute the polymer or the polymerized chain other than the main chain can be conceived as a branched chain or a pendant group with respect to the main chain. Although it depends on the mass average molecular weight of the branched chain regarded as a branched chain or pendant group, the longest chain among the molecular chains that constitute the polymer or the polymerized chain is typically the main chain. However, the main chain does not include a terminal group that is provided in the terminal of the polymer or the polymerized chain. In addition, side chains of the polymer refer to branched chains other than the main chain and include a short chain and a long chain.

In the present invention, (meth)acryl means one or both of acryl and methacryl. The same applies to (meth)acrylate.

In the present invention, a polymer binder (also simply referred to as a binder) means a binder composed of a polymer and includes a polymer itself and a binder composed (formed) by containing a polymer.

### Electrode Sheet for All-Solid State Secondary Battery

An electrode sheet for an all-solid state secondary battery according to the embodiment of the present invention (hereinafter, may be simply referred to as an “electrode sheet”) is an electrode sheet comprising an active material layer on at least one surface of a collector, in which the active material layer has an inorganic solid electrolyte (A) and an active material (B), and satisfies Expression (1) and Expression (2) described later. In a case where the active material layer contains the inorganic solid electrolyte (A) and the active material (B) and satisfies Expression (1) and Expression (2) described later, it is possible to ensure sufficient electron conductivity and ion conductivity (ion conductivity of a metal belonging to Group 1 or Group 2 in the periodic table) while strengthening the particle adhesive force and the interlayer adhesive force in the first virtual divided active material layer provided on the surface of the collector. In addition, the interface adhesive force between the first virtual divided active material layer and the second virtual divided active material layer can also be strengthened, and the peeling between the first virtual divided active material layer and the second virtual divided active material layer can be suppressed. As a result, the electrode sheet according to the embodiment of the present invention can suppress the deterioration in the performance of the electron conductivity or the like even in a case of being subjected to repeated vibration.

The electrode sheet according to the embodiment of the present invention can suppress the deterioration in the performance of the electron conductivity even after being subjected to repeated vibration, and for example, it can achieve an excellent characteristic that the rate of change in an electron conductivity σ2 after a vibration test with respect to an electron conductivity σ1 before the vibration test: (1−σ2/σ1)×100 (%), which is described in the section of Examples later, is less than 50%, and it can achieve a rate of change of desirably less than 40%. In a case where the electrode sheet for an all-solid state secondary battery has other layers such as a solid electrolyte layer and a protective layer on the active material layer which is laminated on the collector, these layers are removed and the vibration test is carried out.

In a case where the electrode sheet according to the embodiment of the present invention, which exhibits the above-described excellent characteristics, is incorporated as an electrode of an all-solid state secondary battery, an all-solid state secondary battery having excellent cycle characteristics can be realized.

In the present invention, “the electrode sheet for an all-solid state secondary battery” includes both aspects of an aspect as a constitutional member of an all-solid state secondary battery (a state of being incorporated into a secondary battery) and an aspect as an electrode material which is before being incorporated into an all-solid state secondary battery, as long as it has the configuration defined in the present invention. Therefore, the form of the “electrode sheet for an all-solid state secondary battery” is applied without being particularly limited to the form according to both of the above-described aspects, and for example, it may be sheet-shaped (film-shaped) or striped, and may be long or short (sheet body). In a case of being an electrode material, it is preferable to have a long sheet shape.

The electrode sheet according to the embodiment of the present invention may comprise an active material layer on at least one surface of the collector, and may comprise the active material layer on both surfaces of the collector. The active material layer may be composed of a single layer or may be composed of multiple layers.

The electrode sheet according to the embodiment of the present invention may have the above-described configuration or may have another layer (film). Examples of the other layer include a protective layer (a peeling sheet) and a coating layer. Furthermore, a base material that supports the electrode sheet may be provided separately from the collector. In addition, the electrode sheet according to the embodiment of the present invention can also be a laminate having a solid electrolyte layer on the active material layer and a laminate having another active material layer on the solid electrolyte layer. The electrode sheet according to the embodiment of the present invention is laminated in a state where the collector and the active material layer are in contact with each other without having another layer between the collector (including a collector with a surface coating layer described later) and the active material layer.

The total thickness L of the active material layer in the electrode sheet according to the embodiment of the present invention is not particularly limited, and is appropriately set according to the kind of the battery, the battery performance, and the like. For example, the total thickness L is preferably 30 to 500 μm, more preferably 50 to 350 μm, and still more preferably 100 to 350 μm. In a case where the electrode sheet according to the embodiment of the present invention is used as an electrode for an all-solid state secondary battery, the layer thickness of each of the above-described layers constituting the electrode sheet according to the embodiment of the present invention is the same as the layer thickness of each of the layers described later in the all-solid state secondary battery, and is a value measured in the same manner as in the method described in the section of Examples later.

The electrode sheet according to the embodiment of the present invention may be configured as a positive electrode sheet for an all-solid state secondary battery (may be simply referred to as a positive electrode sheet) or may be configured as a negative electrode sheet for an all-solid state secondary battery (may be simply referred to as a negative electrode sheet), and the positive electrode sheet or the negative electrode sheet is appropriately selected depending on the use application and the like. In particular, it is preferable that the electrode sheet is a positive electrode sheet (positive electrode active material layer) that is likely to have a decrease in adhesive force due to repeated vibration, by using the above-described strong adhesive force.

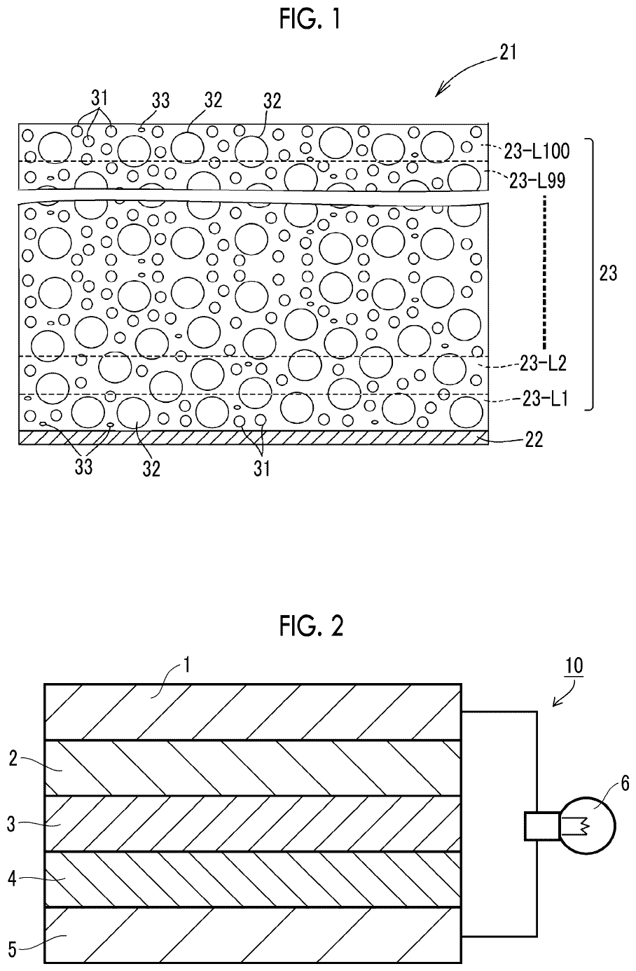

FIG. 1 is a view schematically showing a cross section perpendicular to a longitudinal direction of the electrode sheet, for a preferred embodiment of the electrode sheet according to the embodiment of the present invention. However, in order to more clearly show a first virtual divided active material layer 23-L1 and the like, the intermediate portion in the thickness direction of the active material layer 23 is omitted. In addition, the sizes or the relative magnitudes of the collector, the active material layer, and each component may be changed for convenience of description, and the presence position, the presence amount (content), and the like of each component constituting the active material layer 23 may be changed for convenience of description, and all of them do not indicate the actual magnitudes, the presence positions, the presence amounts, and the like. In addition, a material containing a carbon atom is present in a blank portion of the active material layer 23, and the cross section thereof should be indicated by “diagonal lines”. However, in FIG. 1, in order to facilitate visual recognition, the “diagonal lines” indicating the cross section are omitted.

Hereinafter, the electrode sheet according to the embodiment of the present invention will be described with reference to FIG. 1 as appropriate.

An electrode sheet 21 shown in FIG. 1 has an active material layer 23 on one surface of a collector 22. The active material layer 23 has an inorganic solid electrolyte (A) 31, an active material (B) 32, a polymer binder (C) (not shown), and a conductive auxiliary agent (D) (not shown), and in some cases, has a void 33.

### Collector

A collector that constitutes the electrode sheet according to the embodiment of the present invention is not particularly limited as long as a collector is typically used for a secondary battery, and it is preferably an electron conductor. Examples of the material that forms the collector include a metal or a conductive resin, and it is preferable that an appropriate material is selected depending on the use application (a positive electrode collector or a negative electrode collector) of the collector. For example, in a case of being used as a positive electrode collector, examples of the material include not only aluminum, an aluminum alloy, stainless steel, nickel, titanium, and the like, but also a material obtained by treating a surface of aluminum or stainless steel with carbon, nickel, titanium, or silver (a material on which a thin film is formed, and also referred to as a collector with a surface coating layer), and among these, aluminum and an aluminum alloy are preferable. On the other hand, in a case of being used as a negative electrode collector, examples of the material include not only aluminum, copper, a copper alloy, stainless steel, nickel, titanium, and the like, but also a material obtained by treating a surface of aluminum, copper, a copper alloy, or stainless steel with carbon, nickel, titanium, or silver (also referred to as a collector with a surface coating layer), and among these, copper, a copper alloy, and stainless steel are more preferable.

Regarding the shape of the collector, a film sheet shape is typically used, but it is also possible to use a collector having a shape a net shape or a punched shape, or a collector of a lath body, a porous body, a foaming body, a molded body of a fiber group, or the like.

The thickness of the collector is not particularly limited, and is, for example, preferably 3 to 50 μm and more preferably 5 to 25 μm.

It is also preferable that the surface of the collector is made to be uneven through a surface treatment.

In the present invention, any one of the positive electrode collector or the negative electrode collector, or collectively both of them may be simply referred to as the collector.

### Active Material Layer

The active material layer included in the electrode sheet according to the embodiment of the present invention contains an inorganic solid electrolyte (A) and an active material (B), a material containing a carbon atom, and further appropriately contains various additives. The material containing a carbon atom (may also be referred to as a carbon-containing material) may be a material containing a carbon atom as a constituent atom essential for the material (component) to exhibit its function among materials (components) that form (constitute) an active material layer of an all-solid state secondary battery, and examples thereof include a carbon material as a negative electrode active material, a polymer binder (C), a conductive auxiliary agent (D), and a material containing a carbon atom among other components described later. In the present invention, in a case where a part of a certain component, for example, a coating layer or a surface layer, in core shell particles or the like contains carbon atoms, even though the remainder (for example, a core) of the certain component does not contain carbon atoms, the entire certain component is regarded as a carbon-containing material. On the other hand, in a case where an active material (for example, a metal oxide or silicon) in which a carbon atom is not an essential constituent atom is carbon-coated, the carbon-coated active material does not correspond to the carbon-containing material. It is preferable that the active material layer does not contain an organic solid electrolyte. The details of each of the components will be described later.

In the present invention, any one of the positive electrode active material layer and the negative electrode active material layer, or collectively both of them may be simply referred to as the active material layer.

In a case of focusing on the presence (containing) state of the material constituting the active material layer in a cross section in the thickness direction thereof, the active material layer satisfies Expression (1) and Expression (2).

In the present invention, the cross section of the active material layer may be a cross section in a case where the electrode sheet is cut along the longitudinal direction thereof, or may be a cross section (cross section shown in FIG. 1) in a case where the electrode sheet is cut perpendicular to the longitudinal direction thereof.

$$\begin{matrix}1.4 < S 1 / S 100 & Expression ( 1 ) \\ 0.05 < S 1 < 0.60 & Expression ( 2 )\end{matrix}$$

In Expression (1) and Expression (2), S1 represents an area ratio of a total area of a material containing a carbon atom with respect to an entire area of a cross-sectional region having a layer thickness of 1% or less of the active material layer from the surface of the collector. In the present invention, the entire area of the cross-sectional region refers to the total area (actual cross-sectional area) of the components constituting the active material layer appearing in the cross section, and the area of the void portion appearing in the cross section is not included.

In other words, in a case of assuming that a virtual divided active material layer having 100 layers is obtained by dividing the active material layer 23 into 100 equal parts in the thickness direction, and the first virtual divided active material layer 23-L1 to a one hundredth virtual divided active material layer 23-L100 are arranged in order from a collector 22 side toward the surface of the active material layer 23, the S1 can be expressed as an area ratio, (S-L1C)/(S-L1A), of a total area S-L1C of a material containing a carbon atom with respect to an entire area S-L1A of the first virtual divided active material layer 23-L1.

In Expression (1), S100 represents an area ratio of the total area of the material containing a carbon atom with respect to an entire area of a cross-sectional region having a layer thickness of more than 1% of the active material layer from the surface of the collector.

In other words, in a case of assuming that a virtual divided active material layer having 100 layers is obtained by dividing the active material layer 23 into 100 equal parts in the thickness direction, and the first virtual divided active material layer 23-L1 to the one hundredth virtual divided active material layer 23-L100 are arranged in order from the collector 22 side toward the surface of the active material layer 23, S100 can be expressed as an area ratio, (S-L2−100C)/(S-L2−100A), of a total area S-L2−100C of the material containing a carbon atom with respect to an entire area S-L2−100A of an entire 99 layers of the virtual divided active material layer from a second virtual divided active material layer 23-L2 to the one hundredth virtual divided active material layer 23-L100.

The present inventors have conducted studies focusing on the state of presence of the component constituting the active material layer, for example, the polymer binder (C), the inorganic solid electrolyte (A), the active material (B), and the conductive auxiliary agent (D) as described above, and have found that, in a case where the conductive auxiliary agent (D) is present in the vicinity of the collector to ensure the electron conductivity with the collector, the state of presence of the polymer binder (C) having a low content of the organic substance among the components constituting the active material layer with respect to the inorganic solid electrolyte (A) and the active material (B) having a typically high content of the inorganic substance contributes to the strengthening of the adhesive force. As a result of further studies, it was found through various experiments that in a case where the carbon-containing material in the active material layer is present (unevenly distributed) in the vicinity of the collector so as to satisfy Expression (1) and Expression (2), it is possible to strengthen all of the particle adhesive force, the interface adhesive force, and the interlayer adhesive force in a well-balanced manner while maintaining the electron conductivity and the ion conductivity.

In the present invention, the carbon-containing material preferably includes the polymer binder (C) and the conductive auxiliary agent (D) among the above-described respective components, and more preferably is the polymer binder (C) and the conductive auxiliary agent (D).

In the present invention, S1 defines the presence proportion (uneven distribution state) of the carbon-containing material in the first virtual divided active material layer 23-L1, and contributes to achieving the balance between the strengthening of the particle adhesive force and the interlayer adhesive force in the first virtual divided active material layer 23-L1 and the bipolar conductivity (the ion conductivity and the electron conductivity) between the layers of the collector and the first virtual divided active material layer 23-L1. Therefore, in a case where the active material layer satisfies Expression (2), the active material layer is an active material layer having strengthened particle adhesive force and interlayer adhesive force and excellent bipolar conductivity. In addition, by setting the first virtual divided active material layer 23-L1 to a thickness region corresponding to 1% of the total layer thickness of the active material layer, the interface adhesive force between the first virtual divided active material layer 23-L1 and the second virtual divided active material layer 23-L2 can also be reinforced while maintaining the bipolar conductivity.

From the viewpoint that the particle adhesive force and the interlayer adhesive force can be further strengthened while maintaining the bipolar conductivity, the lower limit value of S1 is preferably 0.10 or more, more preferably 0.20 or more, still more preferably 0.40 or more, and particularly preferably 0.45 or more. On the other hand, from the viewpoint that excellent bipolar conductivity can be ensured while maintaining the particle adhesive force and the interlayer adhesive force, the upper limit value of S1 is preferably 0.59 or less, more preferably 0.58 or less, still more preferably 0.57 or less, and particularly preferably 0.55 or less.

The measuring method of S1 will be described later in the section of Examples.

In the present invention, the presence ratio (content ratio) of the polymer binder (C) to the conductive auxiliary agent (D) in the carbon-containing material present in the first virtual divided active material layer 23-L1 is not particularly limited and can be appropriately determined in consideration of the balance between the adhesive force and the conductivity. For example, a mass ratio (C_{C}:C_{D}) of the content C_{C} of the polymer binder (C) to the content C_{D} of the conductive auxiliary agent (D) is preferably 1.0:0.0005 to 1:1.0, and more preferably 1.0:0.01 to 1:0.70. The mass ratio (C_{C}:C_{D}) can also be set to the same range as the mass ratio in the entire 99 layers of the virtual divided active material layer depending on the coating amount of the first electrode composition.

In the present invention, S1/S100 defines a ratio of the presence proportion (uneven distribution state) of the carbon-containing material in the first virtual divided active material layer 23-L1 and the entire 99 layers of the virtual divided active material layer from the second virtual divided active material layer 23-L2 to the one hundredth virtual divided active material layer 23-L100. The S1/S100 contributes to achieving the balance between the strengthening of the interface adhesive force between the first virtual divided active material layer 23-L1 and the second virtual divided active material layer 23-L2 and the particle adhesive force in the entire 99 layers of the virtual divided active material layer, and the bipolar conductivity in the entire 99 layers of the virtual divided active material layer. Typically, the active material layer is easily peeled off by the repeated vibration of the interface where the components constituting the active material layer change, for example, the interface between the first virtual divided active material layer 23-L1 and the second virtual divided active material layer 23-L2 in the active material layer according to the embodiment of the present invention. However, in a case where the active material layer satisfies Expression (1), the interface adhesive force is particularly strengthened, and the active material layer is an active material layer having excellent interface adhesive force, particle adhesive force, and bipolar conductivity.

From the viewpoint that the interface adhesive force and the particle adhesive force can be further strengthened while ensuring the bipolar conductivity, the lower limit value of S1/S100 is preferably 1.4 or more, more preferably 2.0 or more, and still more preferably 4.0 or more. On the other hand, the upper limit value of S1/S100 is not particularly limited and can be appropriately determined. For example, from the viewpoint that excellent bipolar conductivity can be ensured while maintaining the adhesive force, the upper limit value of S1/S100 is preferably 100 or less, more preferably 10 or less, and still more preferably 7.0 or less.

The measuring method of S1/S100 will be described later in the section of Examples.

In the present invention, in a case where the active material layer satisfies Expression (1) and Expression (2) at the same time, in the active material layer, the particle adhesive force, the interlayer adhesive force, and the interface adhesive force can be strengthened in a well-balanced manner while ensuring bipolar conductivity, and the collapse of the adhesion state of the solid particles can be effectively suppressed even in a case of being subjected to repeated vibration.

In the present invention, S100 defines the presence proportion (uneven distribution state) of the carbon-containing material in the entire 99 layers of the virtual divided active material layer from the second virtual divided active material layer 23-L2 to the one hundredth virtual divided active material layer 23-L100. S100 contributes to achieving the balance between the strengthening of the particle adhesive force in the entire 99 layers of the virtual divided active material layer and the bipolar conductivity in the entire 99 layers of the virtual divided active material layer, and can further reinforce the strengthening of the interface adhesive force according to Expression (1). S100 can be set to an appropriate range in consideration of Expression (1) and the like. For example, from the viewpoint that the bipolar conductivity can be ensured while strengthening the particle adhesive force and the interface adhesive force, it is preferable that the active material layer satisfies Expression (3).

$$0.005 < S 100 < 0.30 \qquad Expression ( 3 )$$

From the viewpoint that the particle adhesive force and the interface adhesive force can be further strengthened while ensuring bipolar conductivity, the lower limit value of S100 is preferably 0.006 or more, more preferably 0.01 or more, and still more preferably 0.05 or more. On the other hand, from the viewpoint that excellent bipolar conductivity can be ensured while maintaining the adhesive force, the upper limit value of S100 is preferably 0.20 or less and more preferably 0.15 or less.

The measuring method of S100 will be described later in the section of Examples.

In the present invention, the presence ratio (content ratio) of the polymer binder (C) to the conductive auxiliary agent (D) in the carbon-containing material present in the entire 99 layers of the virtual divided active material layer is not particularly limited and can be appropriately determined in consideration of the balance between the adhesive force and the conductivity. For example, a mass ratio (C_{C}:C_{D}) of the content C_{C} of the polymer binder (C) to the content C_{D} of the conductive auxiliary agent (D) is preferably 1.0:0.3 to 1:20, and more preferably 1.0:0.6 to 1:12.

In the present invention, from the viewpoint that the adhesive force can be further strengthened and the bipolar conductivity can be ensured, it is preferable that the active material layer satisfies Expression (4).

$$0.010 < ( S 1 / S 100 ) / L < 0.100 \qquad Expression ( 4 )$$

In Expression (4), L represents a layer thickness of the active material layer, and S1 and S100 are as described above.

The “(S1/S100)/L” is obtained by dividing the ratio of the presence proportion of the carbon-containing material in the first virtual divided active material layer 23-L1 to the entire 99 layers of the virtual divided active material layer by the total layer thickness L of the active material layer, and indirectly defines a suitable layer thickness of the first virtual divided active material layer 23-L1 with respect to the total layer thickness L of the active material layer.

From the viewpoint of strengthening the adhesive force and ensuring the bipolar conductivity, (S1/S100)/L is preferably 0.011 to 0.030, more preferably 0.015 to 0.030, and still more preferably 0.015 to 0.027.

The layer thickness L of the active material layer is as described above, but in a case where the active material layer is formed by a preferred method described later, the layer thickness T_{C} of the first electrode composition (after drying) in the active material layer is not particularly limited, and it can be set to, for example, 0.1 to 1.5 μm, and preferably 0.2 to 1.0 μm. The layer thickness T_{C1} can be set to 0.10 to 0.80, preferably 0.10 to 0.70, and more preferably 0.40 to 0.60, as a ratio [T_{C1}/T_{L1}] of a layer thickness (layer thickness of the first virtual divided active material layer 23-L1) T_{L1} of 1% of the layer thickness of the active material layer from the surface of the collector. The layer thickness T_{C1} is a value measured in the same manner as in the method described in the section of Examples later.

Hereinafter, the components forming the active material layer will be described.

### Inorganic Solid Electrolyte (A)

The active material layer contains an inorganic solid electrolyte (A).

In the present invention, the inorganic solid electrolyte is an inorganic solid electrolyte, where the solid electrolyte refers to a solid-shaped electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. From this viewpoint, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like).

The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte (A) include (i) a sulfide-based inorganic solid electrolyte, (ii) an oxide-based inorganic solid electrolyte, (iii) a halide-based inorganic solid electrolyte, and (iv) a hydride-based inorganic solid electrolyte.

The inorganic solid electrolyte (A) preferably does not contain a carbon atom, and for example, (i) the sulfide-based inorganic solid electrolyte, (iii) the halide-based inorganic solid electrolyte, and (iv) the hydride-based inorganic solid electrolyte are more preferable, and from the viewpoint that a good interface can be formed with the active material (B) described later, (i) the sulfide-based inorganic solid electrolyte is still more preferable.

### (i) Sulfide-Based Inorganic Solid Electrolyte

The sulfide-based inorganic solid electrolyte is preferably a compound that contains a sulfur atom, has ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity, and the sulfide-based inorganic solid electrolytes may appropriately include elements other than Li, S, and P (excluding carbon atoms).

Examples of the sulfide-based inorganic solid electrolyte include a lithium ion-conductive inorganic solid electrolyte satisfying the composition represented by Expression (I).

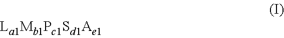

In Expression (I), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1: el satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. el is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited, and it is practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—Si_{S}2—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the respective raw materials does not matter. Examples of the method of synthesizing a sulfide-based inorganic solid electrolyte material using the above-described raw material compositions include an amorphorization method. Examples of the amorphorization method include a mechanical milling method, a solution method, and a melting quenching method. This is because treatments at a normal temperature are possible, and it is possible to simplify manufacturing processes.

### (ii) Oxide-Based Inorganic Solid Electrolyte

The oxide-based inorganic solid electrolyte is preferably a compound that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited, and it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn. xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{CC}_{zc}O_{nc} (M^{CC} is one or more elements selected from S, Al, Si, Ga, Ge, In, and Sn. xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{za}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number of 0 or more and 0.1 or less, and Mₑₑ represents a divalent metal atom. D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O−SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3—yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has ion conductivity of a metal belonging to Group 1 or Group 2 in the periodic table, and has electron-insulating properties.

The halide-based inorganic solid electrolyte is not particularly limited, and examples thereof include LiCl, LiBr, LiI, and compounds such as Li₃YBr₆ or Li₃YCl₆ described in ADVANCED MATERIALS, 2018, 30, 1803075. Among these, Li₃YBr₆ or Li₃YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited, and examples thereof include LiBH₄, Li₄(BH₄)₃I, and 3LiBH₄—LiCl.

The inorganic solid electrolyte (A) is preferably a particle. The shape of the particle is not particularly limited and may be a flat shape, an amorphous shape, or the like, and a spherical shape or a granular shape is preferable. In a case where the inorganic solid electrolyte (A) has a particle shape, the particle diameter (volume average particle diameter) of the inorganic solid electrolyte is not particularly limited, but is preferably 0.01 μm or more and more preferably 0.1 μm or more. The upper limit is preferably 100 μm or less and more preferably 50 μm or less. In order to set the inorganic solid electrolyte (A) to a predetermined particle diameter, a typical pulverizer or classifier may be used, and examples thereof include a method described for the negative electrode active material.

The particle diameter of the inorganic solid electrolyte is measured according to the following procedure. The particles of the inorganic solid electrolyte are diluted using water (heptane in a case where the material is unstable in water) in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. For other detailed conditions and the like, Japanese Industrial Standards (JIS) Z8828: 2013 “particle diameter Analysis-Dynamic Light Scattering” is referred to as necessary. Five samples per level are produced, and the average values therefrom are employed.

One kind of the inorganic solid electrolyte (A) may be used alone, or two or more kinds thereof may be used in combination.

In the active material layer, the total mass (mg) (basis weight) of the inorganic solid electrolyte and the active material per unit area (cm²) is not particularly limited. The basis weight can be appropriately determined depending on the designed battery capacity, and for example, 1 to 100 mg/cm² is preferable.

From the viewpoint of ion conductivity and adhesive force, the content of the inorganic solid electrolyte (A) in the active material layer is preferably 50% by mass or more, more preferably 70% by mass or more, and particularly preferably 90% by mass or more in 100% by mass of the solid content, as the total content of the active material (B) used in combination. From the same viewpoint, the upper limit thereof is preferably 99.9% by mass or less, more preferably 99.5% by mass or less, and particularly preferably 99% by mass or less.

The content of the inorganic solid electrolyte (A) in each virtual divided active material is appropriately determined within a range satisfying the above-described Expression (1) and Expression (2), preferably further the above-described Expression (3) and/or Expression (4), in consideration of the above-described content of the entire active material layer.

### Active Material (B)

The active material (B) is capable of intercalating and deintercalating an ion of a metal belonging to Group 1 or Group 2 in the periodic table. Examples of such an active material include a positive electrode active material and a negative electrode active material, which will be described below, and the active material layer contains a positive electrode active material or a negative electrode active material depending on the use application of the electrode sheet according to the embodiment of the present invention.

The active material (B) preferably does not contain a carbon atom, and the positive electrode active material is more preferably a transition metal oxide, and the negative electrode active material is more preferably a metal oxide or a metal capable of forming an alloy with lithium, such as Sn, Si, Al, and In.

In the present invention, any one of the positive electrode active material or the negative electrode active material, or collectively both of them may be simply referred to as an active material or an electrode active material.

### Positive Electrode Active Material

The positive electrode active material is an active material that is capable of intercalating and deintercalating an ion of a metal belonging to Group 1 or Group 2 in the periodic table, and it is preferably one capable of reversibly intercalating and deintercalating a lithium ion. The above-described material is not particularly limited as long as the material has the above-described characteristics, and the material may be a transition metal oxide, an organic substance, an element capable of being complexed with Li, such as sulfur, or the like.

Among these, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount is preferably 0% to 30% by mol with respect to the amount (100% by mol) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include an iron fluorophosphate such as Li₂FePO₄F, a manganese fluorophosphate such as Li₂MnPO₄F, and a cobalt fluorophosphate such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. In a case where the positive electrode active material has a particle shape, the (volume average) particle diameter (sphere equivalent average particle diameter) of the positive electrode active material is not particularly limited. For example, the particle diameter can be set to 0.1 to 50 μm. In order to set the positive electrode active material to a predetermined particle diameter, a typical pulverizer or classifier may be used, and examples thereof include a method described for the negative electrode active material. A positive electrode active material obtained using a baking method may be used after being washed with water, an acidic aqueous solution, an alkaline aqueous solution, or an organic solvent. The particle diameter of the positive electrode active material particles can be measured in the same manner as the measurement of the particle diameter of the inorganic solid electrolyte.

One kind of the positive electrode active material may be used alone, or two or more kinds thereof may be used in combination.

In a case of forming a positive electrode active material layer, the mass (mg) (basis weight) of the positive electrode active material per unit area (cm²) in the positive electrode active material layer is not particularly limited. The basis weight can be appropriately determined depending on the designed battery capacity, and for example, 1 to 100 mg/cm² is preferable.

The content of the positive electrode active material in the active material layer is not particularly limited, and is preferably 10% to 97% by mass, more preferably 30% to 95% by mass, still more preferably 40% to 93% by mass, and particularly preferably 50% to 90% by mass.

The content of the positive electrode active material in each virtual divided active material is appropriately determined within a range satisfying the above-described Expression (1) and Expression (2), preferably further the above-described Expression (3) and/or Expression (4), in consideration of the above-described content of the entire active material layer.

### Negative Electrode Active Material

The negative electrode active material is an active material that is capable of intercalating and deintercalating an ion of a metal belonging to Group 1 or Group 2 in the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material capable of forming an alloy (capable of being alloyed) with lithium. Among these, a metal oxide, a metal composite oxide, a lithium single body, a lithium alloy, or a negative electrode active material capable of forming an alloy with lithium is preferable, and a metal composite oxide or a lithium single body is more preferable from the viewpoint of reliability. An active material that is capable of being alloyed with lithium is more preferable from the viewpoint that the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Further, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material, and may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably amorphous oxides, and preferred examples thereof include chalcogenides which are reaction products between metal elements and elements in Group 16 in the periodic table. In the present invention, the metalloid element refers to an element having intermediate properties between those of a metal element and a non-metalloid element. Typically, the metalloid elements include six elements including boron, silicon, germanium, arsenic, antimony, and tellurium, and further include three elements including selenium, polonium, and astatine. In addition, “amorphous” means an oxide having a broad scattering band with an apex in a range of 20° to 40° in terms of 2θ value in case of being measured by an X-ray diffraction method using CuKα rays, and the oxide may have a crystalline diffraction line. The highest intensity in a crystalline diffraction line observed in a range of 40° to 70° in terms of 2θ value is preferably 100 times or less and more preferably 5 times or less with respect to the intensity of a diffraction line at the apex in a broad scattering band observed in a range of 20° to 40° in terms of 2θ value, and it is particularly preferable that the oxide does not have a crystalline diffraction line.

In the compound group consisting of the amorphous oxides and the chalcogenides, amorphous oxides of metalloid elements and chalcogenides are more preferable, and (composite) oxides consisting of one element alone or a combination of two or more elements selected from elements (for example, Al, Ga, Si, Sn, Ge, Pb, Sb, and Bi) belonging to Group 13 (IIIB) to 15 (VB) in the periodic table or chalcogenides are particularly preferable. Specific examples of the preferred amorphous oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with an amorphous oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable from the viewpoint that since the volume variation during the intercalation and deintercalation of lithium ions is small, the high-speed charging and discharging characteristics are excellent, and the deterioration of electrodes is suppressed, whereby it is possible to improve the life of the lithium ion secondary battery.

The lithium alloy as the negative electrode active material is not particularly limited as long as the alloy is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the binder described above, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mol or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (such as graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOₓ (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. It is noted that in addition, since SiOₓ itself can be used as a negative electrode active material (a metalloid oxide) and Si is produced along with the operation of an all-solid state secondary battery, SiOₓ can be used as a negative electrode active material (or a precursor material thereof) capable of being alloyed with lithium.

Examples of the negative electrode active material including the tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without being particularly limited. However, from the viewpoint of battery capacity, a preferred aspect as the negative electrode active material is a negative electrode active material that is capable of being alloyed with lithium. Among these, the silicon material or the silicon-containing alloy (the alloy containing a silicon element) described above is more preferable, and it is still more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. In a case where the negative electrode active material has a particle shape, the particle diameter of the negative electrode active material is preferably 0.1 to 60 μm.

A method of adjusting the particle diameter to a predetermined particle diameter is not particularly limited, and a known method can be applied. Examples thereof include a method using a typical pulverizer or classifier. As the pulverizer or classifier, for example, a mortar, a ball mill, a sand mill, a vibration ball mill, a satellite ball mill, a planetary ball mill, a swirling airflow-type jet mill, or a sieve is suitably used. During the pulverization, wet-type pulverization of causing water or an organic solvent such as methanol to coexist with the negative electrode active material can be performed as necessary. In order to provide the desired particle diameter, classification is preferably carried out. A classification method is not particularly limited, and a method using, for example, a sieve or a wind classifier can be optionally used. Both a dry-type classification and a wet-type classification can be used. The particle diameter of the negative electrode active material particles can be measured in the same manner as the measurement of the particle diameter of the inorganic solid electrolyte.

One kind of the negative electrode active material may be used alone, or two or more kinds thereof may be used in combination.

In a case of forming a negative electrode active material layer, the mass (mg) (basis weight) of the negative electrode active material per unit area (cm²) in the negative electrode active material layer is not particularly limited. The basis weight can be appropriately determined depending on the designed battery capacity, and for example, 1 to 100 mg/cm² is preferable.

The content of the negative electrode active material in the active material layer is not particularly limited and is preferably 10% to 90% by mass, more preferably 20% to 85% by mass, still more preferably 30% to 80% by mass, and yet still more preferably 40% to 75% by mass.

The content of the negative electrode active material in each virtual divided active material is appropriately determined within a range satisfying the above-described Expression (1) and Expression (2), preferably further the above-described Expression (3) and/or Expression (4), in consideration of the above-described content of the entire active material layer.

### Coating of Active Material

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include spinel titanate, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

### Polymer Binder (C)

The active material layer preferably contains a polymer binder (C) as one kind of carbon-containing material.

As the polymer binder (C), a polymer binder that is typically used for the active material layer of an all-solid state secondary battery can be used without being particularly limited.

Examples of the polymer binder (C) include binders consisting of various polymers, a binder consisting of a rubber-like polymer, and a binder consisting of a non-rubber-like polymer.

In the present invention, the rubber-like polymer refers to a polymer exhibiting rubber elasticity at normal temperature, and examples thereof include a polymer exhibiting a Young's modulus (Japanese Industrial Standards (JIS) K 7161) of 0.001 to 0.030 GPa. On the other hand, the non-rubber-like polymer refers to a polymer that does not exhibit rubber elasticity at normal temperature.

The rubber-like polymer is not particularly limited, and examples thereof include a thermoplastic elastomer and rubber. Examples of the rubber include hydrocarbon rubber such as styrene-butadiene rubber (SBR), isoprene rubber (IR), butadiene rubber (BR), chloroprene rubber (CR), acrylonitrile-butadiene rubber (NBR), or hydrogenated rubber thereof, for example, hydrogenated acrylonitrile-butadiene rubber (HNBR); fluororubber such as polyvinylidene difluoride (PVDF), a copolymer of vinylidene fluoride and hexafluoropropylene (PVDF-HFP), and polytetrafluoroethylene (PTFE); acrylic rubber such as an acrylic polymer; ethylene-propylene rubber; and cellulose rubber.

Examples of the thermoplastic elastomer include a styrene-based elastomer, an olefin-based elastomer, a urethane-based elastomer, an ester-based elastomer, an amide-based elastomer, and a hydride thereof. The styrene-based elastomer is not particularly limited, and examples thereof include a styrene-ethylene-butylene-styrene block copolymer (SEBS), a hydrogenated (saturated) SEBS, a styrene-isoprene-styrene block copolymer (SIS), a hydrogenated SIS, a styrene-butadiene-styrene block copolymer (SBS), a hydrogenated SBS, a styrene-isobutylene-styrene block copolymer (SIBS), a hydrogenated SIBS, a styrene-ethylene-ethylene-propylene-styrene block copolymer (SEEPS), a styrene-ethylene-propylene-styrene block copolymer (SEPS), a styrene-butadiene rubber (SBR), and a hydrogenated styrene-butadiene rubber (HSBR).

As the rubber-like polymer, a hydrocarbon rubber, an acrylic rubber, or a styrene-based elastomer is preferable.

The non-rubber-like polymer is not particularly limited, and examples thereof include a thermoplastic resin and a thermosetting resin. Examples of the thermoplastic resin and the thermosetting resin include acrylic resins such as polymethyl methacrylate (PMMA) and a (co)polymer of an alkyl acrylate ester; polyvinyl chloride (PVC); hydrocarbon resins such as polyethylene (PE), ultra-high-molecular-weight polyethylene (U-PE), polypropylene (PP), a copolymer of acrylonitrile, butadiene, and styrene (ABS), and a copolymer of acrylonitrile and styrene (AS); polystyrene (PS); polyvinyl alcohol (PVA); polyvinylidene chloride (PVDC); polyacetal (POM); fluororesins such as polyvinylidene fluoride (PVDF) and polytetrafluoroethylene (PTFE); polysulfone (PSU); polyether sulfone (PES); polyphenylene sulfide (PPS); polyarylate (PAR); polyamide imide (PAI); polyether imide (PEI); polyurethane; polyurea; polyamide; polyimide; polyester such as polyethylene terephthalate (PET) and polybutylene terephthalate (PBT); polyether such as polyphenylene ether (PPE) and polyether ether ketone (PEEK); polycarbonate; and liquid crystal polymer (LCP).

As the non-rubber-like polymer, an acrylic resin is preferable.

It is preferable that the polymer that forms the polymer binder (C) is a linear polymer, that is, a polymer that does not have a polymerized chain as a side chain component, for example, a polymer that does not have a constitutional component derived from a macromonomer. Examples of the macromonomer include the macromonomer A described in WO2019-230592A. As the macromonomer A, the contents described in WO2019-230592A can be appropriately referred to, and the contents are incorporated as they are as a part of the description of the present specification.

### -Physical Properties, Characteristics, or Like of Polymer or Polymer Binder-

The polymer binder (C) or the polymer forming the polymer binder (C) preferably has the following physical properties, characteristics, or the like.

The polymer binder (C) preferably exhibits a characteristic (solubility) of being dissolved in a dispersion medium contained in an electrode composition forming an active material layer. A polymer binder that is dissolved in a dispersion medium is referred to as a soluble type binder. The polymer binder (C) in the electrode composition is typically present in a state of being dissolved in the dispersion medium in the electrode composition, although it depends on the content thereof, the solubility thereof described later, the content of the dispersion medium, and the like. As a result, since the active material layer is formed while maintaining the state in which the polymer binder (C) is appropriately adsorbed to the active material (B) in the electrode composition, the above-described each adhesive force in the active material layer can be effectively reinforced.

In the present invention, the description that the polymer binder (C) is dissolved in the dispersion medium means that, for example, the solubility in the dispersion medium is 10% by mass or more in the solubility measurement. On the other hand, the description that the polymer binder (C) is not dissolved (is insoluble) in a dispersion medium means that the solubility of the dispersion medium in the solubility measurement is less than 10% by mass. The measuring method of solubility is as follows.

A specified amount of a polymer binder (C) serving as a measurement target is weighed in a glass bottle, 100 g of the same dispersion medium as the dispersion medium contained in the electrode composition is added thereto, and stirring is carried out at a temperature of 25° C. on a mix rotor at a rotation speed of 80 rpm for 24 hours. After stirring for 24 hours, the mixed solution obtained in this way is subjected to the transmittance measurement under the following conditions. This test (transmittance measurement) is carried out by changing the amount of the polymer binder (C) dissolved (the above-described specified amount), and the upper limit concentration X (% by mass) at which the transmittance is 99.8% is defined as the solubility of the polymer binder (C) in the above dispersion medium.

### Transmittance Measurement Conditions

Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

In a case where the polymer binder (C) is in a particle shape (does not dissolve in the dispersion medium contained in the electrode composition), the shape thereof is not particularly limited, and may be a flat shape, an amorphous shape, or the like, and a spherical shape or a granular shape is preferable. In this case, the average particle diameter of the polymer binder (C) having a particle shape in the electrode composition is not particularly limited, but is preferably 1 nm or more, more preferably 10 nm or more, and still more preferably 30 nm or more. The upper limit value is preferably 5 μm or less and more preferably 1 μm or less. The average particle diameter of the polymer binder (C) can be measured in the same manner as the particle diameter of the inorganic solid electrolyte. The average particle diameter of the polymer binder (C) can be adjusted by, for example, the kind of the dispersion medium, the composition of the polymer forming the polymer binder, and the like.

The mass average molecular weight of the polymer is not particularly limited. It is, for example, preferably 5,000 or more, more preferably 30,000 or more, and still more preferably 50,000 or more. The upper limit is practically 5,000,000 or less, but is preferably 500,000 or less, more preferably 300,000 or less, and still more preferably 200,000 or less.

The mass average molecular weight of the polymer can be appropriately adjusted by changing the kind, content, polymerization time, polymerization temperature, and the like of the polymerization initiator.

### -Measurement of Molecular Weight-

In the present invention, unless otherwise specified, the molecular weight of the polymer or the polymerized chain (a constitutional component having a polymerized chain) refers to a mass average molecular weight in terms of standard polystyrene conversion, which are determined by gel permeation chromatography (GPC). The measuring method thereof includes, basically, a method in which conditions are set to Condition 1 or Condition 2 (preferential) described later. However, depending on the kind of polymer or polymerized chain an appropriate eluent may be selected and used.

### Condition 1

Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

### Condition 2

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation) is used
Carrier: tetrahydrofuran
Measurement temperature: 40° C.
Carrier flow rate: 1.0 ml/min
Sample concentration: 0.1% by mass
Detector: refractive index (RI) detector

The moisture concentration of the polymer is preferably 100 ppm (in terms of mass) or lower. In addition, the polymer may be dried by crystallization, or the polymer liquid may be used as it is.

The polymer is preferably amorphous. In the present invention, the description that a polymer is “amorphous” typically refers to that no endothermic peak due to crystal melting is observed in a case where the measurement is carried out at the glass transition temperature.

The polymer may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the above-described range at the start of use of the all-solid state secondary battery.

The active material layer may contain one kind of polymer binder (C), but from the viewpoint of the adhesive force, it is preferable to contain two or more kinds, and for example, can contain two to five kinds, it is more preferable to contain two or three kinds.

In a case where the active material layer contains one kind of polymer binder (C), a binder consisting of a rubber-like polymer is preferable from the viewpoint that the binder can well follow repeated vibration, bending stress during transportation, and the like, and thus the above-described decrease in each adhesive force can be suppressed.

On the other hand, in a case where the active material layer contains two or more kinds of polymer binders (C), from the viewpoint that the above-described decrease in each adhesive force can be suppressed by well following repeated vibration, bending stress during transportation, and the like, it is preferable that at least one kind of the two or more kinds of polymer binders (C) is a binder consisting of a rubber-like polymer. All of the two or more kinds of polymer binders (C) may be binders consisting of a rubber-like polymer, but at least one kind thereof is preferably a binder consisting of a non-rubber-like polymer, and a combination of at least one binder consisting of a rubber-like polymer and at least one binder consisting of a non-rubber-like polymer is preferable from the viewpoint that the adhesive force can be further strengthened and excessive deformation due to stress can be suppressed.

The first virtual divided active material layer 23-L1 among the active material layers preferably contains a binder consisting of a rubber-like polymer, the second virtual divided active material layer 23-L2 to the ninety-ninth virtual divided active material layer 23-L99 preferably contain a binder consisting of a rubber-like polymer or a binder consisting of a non-rubber-like polymer, and more preferably contain a binder consisting of a non-rubber-like polymer.

The content of the polymer binder (C) in the entire active material layer is not particularly limited, and it can be set to 0.01% by mass or more, but it is, for example, preferably 0.1% to 5.0% by mass, more preferably 0.2% to 4.0% by mass, and still more preferably 0.3% to 2.0% by mass from the viewpoint of the adhesive force and the bipolar conductivity.

The content of the polymer binder (C) in the first virtual divided active material layer 23-L1 is appropriately set within a range satisfying the above-described Expression (1) and Expression (2), preferably further the above-described Expression (3) and/or Expression (4), in consideration of the above-described content of the entire active material layer. For example, from the viewpoint of the adhesive force and the bipolar conductivity, the content of the polymer binder (C) can be set to, for example, 3% by mass or more, preferably 10% by mass or more and less than 100% by mass, and more preferably 25% by mass or more and less than 100% by mass. The upper limit value thereof can be, for example, 60% by mass.

The content of the polymer binder (C) in the 99 layers of the second virtual divided active material layer 23-L2 to the ninety-ninth virtual divided active material layer 23-L99 is appropriately set within a range satisfying the above-described Expression (1) and Expression (2), preferably further the above-described Expression (3) and/or Expression (4), in consideration of the above-described content of the entire active material layer, and for example, it is preferably the same range as the above-described content of the entire active material layer.

### Conductive Auxiliary Agent (D)

The active material layer preferably contains a conductive auxiliary agent (D), and preferably contains a conductive auxiliary agent containing a carbon atom. The conductive auxiliary agent (D) is not particularly limited, and conductive auxiliary agents that are known as general conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, the conductive auxiliary agent (D) preferably includes graphites, carbon blacks, amorphous carbon, carbon fibers, and carbonaceous materials as one of the carbon-containing materials.

In the present invention, among the above-described conductive auxiliary agents, a conductive auxiliary agent that does not intercalate and deintercalate ions (preferably Li ions) of a metal belonging to Group 1 or Group 2 in the periodic table and does not function as an active material in a case of charging and discharging of the battery is classified as the conductive auxiliary agent. Therefore, among the conductive auxiliary agents, a conductive auxiliary agent that can function as the active material in the active material layer in a case of charging and discharging of the battery is classified as an active material but not as a conductive auxiliary agent. Whether or not the conductive auxiliary agent functions as the active material in a case of charging and discharging of a battery is not unambiguously determined but is determined by the combination with the active material.

The conductive auxiliary agent (D) may contain one kind or two or more kinds thereof.

The shape of the conductive auxiliary agent (D) is not particularly limited, but is preferably a particle shape.

The content of the conductive auxiliary agent (D) in the active material layer is not particularly limited, and it is, for example, preferably more than 0% by mass and 20% by mass or less, and more preferably 0.05% to 5% by mass from the viewpoint of the adhesive force and the bipolar conductivity.

The content of the conductive auxiliary agent (D) in the first virtual divided active material layer 23-L1 is appropriately set within a range satisfying the above-described Expression (1) and Expression (2), preferably further the above-described Expression (3) and/or Expression (4), in consideration of the above-described content of the entire active material layer, and for example, it can be set to 10% by mass or less.

### Additive

As other components other than the above-described respective components, the active material layer can contain, as desired, additives such as an ionic liquid, a lithium salt (a supporting electrolyte), a thickener, an anti-foaming agent, a leveling agent, a dehydrating agent, and an antioxidant, at an appropriate content.

In the present invention, among the additives contained in the active material layer, those having a carbon atom are one kind of the carbon-containing material.

Typically, the lithium salt is preferably a lithium salt that is used for this kind of product and is not particularly limited. For example, lithium salts described in paragraphs [0082] to [0085] of JP2015-088486A are preferable. The ionic liquid is contained in order to further improve the ion conductivity, and the known ionic liquid art can be used without being particularly limited.

### Manufacturing Method for Electrode Sheet

The manufacturing method for an electrode sheet according to the embodiment of the present invention is not particularly limited, and examples thereof include a method of forming a film (coating and drying) on a surface of a collector using an electrode composition (composition for forming an active material layer) containing an inorganic solid electrolyte (A), an active material (B), and a dispersion medium. The manufacturing method for an electrode sheet can be carried out in the atmosphere, but it is preferably carried out in an environment such as dry air (dew point: −20° C. or lower) or an inert gas (for example, argon gas, helium gas, or nitrogen gas).

Examples of the method and conditions for forming the active material layer that satisfies Expression (1) and Expression (2) and preferably further Expression (3) and/or Expression (4) include various methods such as a method of changing the composition and viscosity of the electrode composition and a film forming method or film forming conditions for the electrode composition. Specific example thereof includes a method of selecting a material having a specific gravity higher than that of the inorganic solid electrolyte (A) as the carbon-containing material and increasing the time from the coating to the start of the drying to carry out the coating and the drying. In addition, due to an increase in the drying temperature of the electrode composition, improvement of the affinity between the polymer binder (C) and the dispersion medium, and the like, the diffusion (uneven distribution) of the polymer binder (C) in the coating film can be adjusted, and as a result, S1 can be reduced.

Examples of a preferred method of forming the active material layer include a method of forming a film of the first electrode composition on the surface of the collector and then forming a film of the second electrode composition on the surface of the first electrode composition layer. In the active material layer formed by the method, the layer consisting of the first electrode composition and the layer consisting of the second electrode composition may be mixed in the vicinity of an interface therebetween.

The first electrode composition may contain a carbon-containing material and a dispersion medium, and may further contain the inorganic solid electrolyte (A) and the active material (B), as well as an additive as appropriate. Each component is as described above.

The polymer binder (C) contained in the first electrode composition may be one kind or two or more kinds, but it is preferable to include at least one binder consisting of rubber-like polymer.

### Dispersion Medium

It suffices that the dispersion medium contained in the first electrode composition is in a liquid state in the use environment and can disperse or dissolve the above-described respective components, and examples thereof include various organic solvents. Specific examples thereof include an alcohol compound, an ether compound, an amide compound, an amine compound, a ketone compound, an aromatic hydrocarbon compound, an aliphatic hydrocarbon compound, a nitrile compound, and an ester compound.

The dispersion medium may be a non-polar dispersion medium (hydrophobic dispersion medium) or a polar dispersion medium (hydrophilic dispersion medium), but a non-polar dispersion medium is preferable. The non-polar dispersion medium generally means a dispersion medium having a property of a low affinity to water, and in the present invention, examples thereof include an ester compound, a ketone compound, an ether compound, an aromatic hydrocarbon compound, and an aliphatic hydrocarbon compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3-or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic hydrocarbon compound include benzene, toluene, xylene, and perfluorotoluene.

Examples of the aliphatic hydrocarbon compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among these, an ether compound, a ketone compound, an aromatic hydrocarbon compound, an aliphatic hydrocarbon compound, or an ester compound is preferable, and an aromatic hydrocarbon compound or an aliphatic hydrocarbon compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The boiling point of the dispersion medium at normal pressure (1 atm) is not particularly limited. For example, the boiling point is preferably 50° C. or higher and more preferably 70° C. or higher. The upper limit thereof is preferably 250° C. or lower and more preferably 220° C. or lower.

The content of the carbon-containing material in the solid content of the first electrode composition is not particularly limited as long as it satisfies the above-described Expression (1) and Expression (2), and it can be set to, for example, 5% by mass or more, and it is preferably 50% to 100% by mass. In the present invention, in a case where the content of the carbon-containing material is increased, the value of S1 tends to increase.

The content of the polymer binder (C) in the solid content of the first electrode composition is not particularly limited as long as it satisfies the above-described Expression (1) and Expression (2), and it is appropriately set in consideration of the content of the carbon-containing material, and it can be set to, for example, 1% by mass or more, and it is preferably 5% to 100% by mass. In a case where the first electrode composition contains the inorganic solid electrolyte (A) or the active material (B), the content of the polymer binder (C) can be set to 1% to 10% by mass, and is preferably 4% to 8% by mass.

The content of the conductive auxiliary agent (D) in the solid content of the first electrode composition is not particularly limited as long as it satisfies the above-described Expression (1) and Expression (2), and it is appropriately set in consideration of the content of the carbon-containing material, and it can be set to, for example, 5% by mass or less, and it is preferably 0% to 3% by mass.

The content of the inorganic solid electrolyte (A) in the solid content of the first electrode composition is not particularly limited as long as it satisfies the above-described Expression (1) and Expression (2), and it is appropriately set, and it can be set to, for example, 50% by mass or less, and it is preferably 0% to 30% by mass.

The content of the active material (B) in the solid content of the first electrode composition is not particularly limited as long as it satisfies the above-described Expression (1) and Expression (2), and it is appropriately set, and it can be set to, for example, 90% by mass or less, and it is preferably 0% to 80% by mass.

In the present invention, unless otherwise specified, the solid content refers to a component that neither volatilizes nor evaporates and disappears in a case where the composition is dried at 170° C. for 6 hours in a nitrogen atmosphere at an atmospheric pressure of 1 mmHg. Typically, the solid content refers to a component other than a dispersion medium.

The dispersion medium contained in the first electrode composition may be one kind or two or more kinds.

The content of the dispersion medium in the first electrode composition is not particularly limited and can be appropriately set, and for example, it is preferably 15% to 99% by mass, more preferably 20% to 95% by mass, and still more preferably 25% to 95% by mass.

The first electrode composition can be prepared by mixing the above-described respective components and the dispersion medium by an ordinary method. The mixing method is not particularly limited, and the components may be mixed collectively or may be mixed sequentially.

In a case of forming a film of the first electrode composition, the above-described collector is prepared, and the first electrode composition is formed into a film on the surface of the collector to form a first electrode composition layer. The coating method in the film forming method is not particularly limited and can be appropriately selected. Examples thereof include coating (preferably wet-type coating), spray coating, spin coating, dip coating, slit coating, stripe coating, and bar coating.

It is preferable that the first electrode composition is coated to be thinner than the first virtual divided active material layer 23-L1 (a thickness region of 1% with respect to the total layer thickness of the active material layer) to form the first electrode composition layer. As a result, the first virtual divided active material layer 23-L1 is formed together with the second electrode composition layer forming a film on the first electrode composition layer, and an active material layer that satisfies Expression (1) and Expression (2), and preferably further Expression (3) and/or Expression (4) can be formed. In a case where the coating thickness of the first electrode composition is increased or the total layer thickness of the active material layer is decreased, the value of S1 tends to increase. For example, the coating thickness T_{C1A} of the first electrode composition is not particularly limited, and it can be set to, for example, 0.1 to 1.5 μm, and it is preferably 0.2 to 1.0 μm. The coating thickness T_{C1A} can be set to 0.10 to 0.80, preferably 0.10 to 0.70, and more preferably 0.40 to 0.60, as a ratio [T_{C1A}/T_{L1}] of the coating thickness T_{C1A} of the first electrode composition layer with respect to the layer thickness T_{L1} of the first virtual divided active material layer 23-L1.

A drying method and drying conditions for the first electrode composition are not particularly limited and can be appropriately selected. In the present invention, in a case where the drying temperature is increased, the value of S1 tends to decrease. The drying temperature of the first electrode composition is, for example, preferably 30° C. or higher, more preferably 60° C. or higher, and still more preferably 80° C. or higher. The upper limit thereof is preferably 300° C. or lower, more preferably 250° C. or lower, still more preferably 200° C. or lower, and particularly preferably 130° C. or lower. The drying time is not particularly limited and can be appropriately set.

The first electrode composition layer formed in this way can also be pressurized. The pressurizing force in a case of pressurizing is not particularly limited.

In a preferred method of forming the active material layer, the second electrode composition is then used to form a film on the surface of the first electrode composition layer.

The second electrode composition contains an inorganic solid electrolyte (A), an active material layer (B), a carbon-containing material, and a dispersion medium, and may appropriately contain an additive. Each component is as described above.

The polymer binder (C) contained in the second electrode composition may be one kind or two or more kinds, but it is preferably different from the polymer binder contained in the first electrode composition layer, and it is more preferable that the second electrode composition contains at least one kind of a binder consisting of a non-rubber-like polymer or a binder consisting of a rubber-like polymer.

It is preferable that the content of each component in the solid content of the second electrode composition is the same as the content of each component in the active material layer. In the present invention, in a case where the content of the carbon-containing material in the second electrode composition is increased, the value of S100 tends to increase.

The dispersion medium contained in the second electrode composition may be one kind or two or more kinds. The content of the dispersion medium in the second electrode composition is not particularly limited and can be appropriately set, and for example, it is preferably 15% to 99% by mass, more preferably 20% to 70% by mass, and still more preferably 25% to 60% by mass.

The second electrode composition can be prepared by mixing the above-described respective components and the dispersion medium by an ordinary method. The mixing method is not particularly limited, and the components may be mixed collectively or may be mixed sequentially.

In a case of forming a film of the second electrode composition, the second electrode composition is formed into a film on the surface of the first electrode composition layer to form a second electrode composition layer. The coating method and the drying conditions in the film forming method are not particularly limited and are the same as the coating method for the first electrode composition. In the present invention, in a case where the coating thickness of the second electrode composition is increased (the total layer thickness of the active material layer is increased), the value of S100 tends to decrease. In addition, in a case where the drying temperature is increased, the value of S100 tends to increase, and further the void volume in the active material layer tends to increase. In a case of coating the second electrode composition to the surface of the first electrode composition layer, the time taken for the temperature to reach the predetermined drying temperature after the coating of the second electrode composition is completed can be appropriately set, and it can be set to 1 second to 10 minutes and preferably 5 seconds to 1 minute from the viewpoint that the active material layer satisfying Expression (1) and Expression (2) and preferably further Expression (3) and/or Expression (4) can be formed. The time from the completion of the coating of the second electrode composition to the start of the drying can be appropriately set.

The drying of the second electrode composition can be carried out once or can be carried out a plurality of times (for example, 2 to 5 times). In a case of drying the coating film a plurality of times (multi-stage drying method), the drying temperature in each drying process may be the same or different from each other, and in a case of drying at different drying temperatures, it is preferable to set the drying temperature to sequentially increase from the drying process at the first time. The drying temperature at the first time is preferably 80° C. to 120° C. in the above-described range.

The electrode composition layer formed in this way can also be pressurized. The pressurizing condition and the like will be described later in the section of the manufacturing method for an all-solid state secondary battery. The pressurizing force can be set to be lower than the pressurizing force to be applied to the all-solid state secondary battery and can be set to be, for example, 2 to 100 MPa.

In this way, the active material layer that satisfies Expression (1) and Expression (2), and preferably further Expression (3) and/or Expression (4) is formed on the surface of the collector, whereby the electrode sheet according to the embodiment of the present invention is formed.

### All-Solid State Secondary Battery

The all-solid state secondary battery comprising, as an electrode, the electrode sheet according to the embodiment of the present invention has a positive electrode (a positive electrode collector and a positive electrode active material layer), a negative electrode (a negative electrode active material layer and a negative electrode collector) that faces the positive electrode, and a solid electrolyte layer that is disposed between the positive electrode (positive electrode active material layer) and the negative electrode (negative electrode active material layer). In the present invention, at least one of the positive electrode or the negative electrode, preferably at least the positive electrode, and more preferably both electrodes are constituted by the electrode sheet according to the embodiment of the present invention. The collector and the active material layer, which are incorporated into the all-solid state secondary battery and constitute the all-solid state secondary battery, are the same as those in the electrode sheet according to the embodiment of the present invention. That is, the active material layer of the electrode constituted by the electrode sheet according to the embodiment of the present invention also satisfies the characteristics of the active material layer in the electrode sheet according to the embodiment of the present invention, for example, the characteristics of Expression (1), Expression (2), and the like in the all-solid state secondary battery. In a case where one of the positive electrode and the negative electrode is not formed of the electrode sheet according to the embodiment of the present invention, the positive electrode and the negative electrode can be formed using an active material, for example, using a known solid electrolyte composition containing an active material.

The solid electrolyte layer is formed using an inorganic solid electrolyte, for example, using a typical solid electrolyte composition containing a solid electrolyte.

The thickness of each of the negative electrode active material layer, the solid electrolyte layer, and the positive electrode active material layer is not particularly limited. In consideration of a dimension of a general all-solid state secondary battery, the thickness of each of the layers is preferably 10 to 1,000 μm and more preferably 20 μm or more and less than 500 μm.

### Housing

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

Hereinafter, an all-solid state secondary battery according to a preferred embodiment of the present invention will be described with reference to FIG. 2, but the present invention is not limited thereto.

FIG. 2 is a cross-sectional view schematically showing the all-solid state secondary battery (lithium ion secondary battery) according to the preferred embodiment of the present invention. An all-solid state secondary battery 10 according to the present embodiment is a secondary battery in which both the positive electrode and the negative electrode are formed of the electrode sheet according to the embodiment of the present invention. In a case of being seen from the negative electrode side, the all-solid state secondary battery 10 includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example shown in the drawing, an electric bulb is employed as a model at the operation portion 6 and is lit by discharging.

In the present invention, a functional layer, a member, or the like may be appropriately interposed or disposed between or outside the respective layers of the negative electrode active material layer, the solid electrolyte layer, and the positive electrode active material layer. In addition, each layer may be composed of a single layer or may be composed of multiple layers.

The all-solid state secondary battery according to the embodiment of the present invention comprises the electrode consisting of the electrode sheet according to the embodiment of the present invention, and as described above, even in a case of being subjected to repeated vibration, the deterioration in the battery performance can be suppressed, and for example, excellent cycle characteristics are exhibited.

### -Use Application of All-Solid State Secondary Battery-

The all-solid state secondary battery according to the embodiment of the present invention exhibits the above-described excellent characteristics and can be applied to various use applications. Application aspects are not particularly limited, and, in the case of being mounted in electronic apparatuses, examples of the electronic apparatuses include laptop computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, memory cards, portable tape recorders, radios, and backup power supplies. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Further, the all-solid state secondary battery can be used for a variety of military usages and universe usages. In addition, the all-solid state secondary battery can also be combined with a solar battery.

### Manufacturing Method for All-Solid State Secondary Battery

The all-solid state secondary battery according to the embodiment of the present invention can be manufactured by (through) a method of manufacturing using the electrode sheet according to the embodiment of the present invention, and can be manufactured by a known method using the electrode sheet according to the embodiment of the present invention. For example, an all-solid state secondary battery can be manufactured by manufacturing the electrode sheet according to the embodiment of the present invention and forming a solid electrolyte layer using the electrode sheet. Specifically, the solid electrolyte layer may form a film on the electrode or may be disposed or transferred to the electrode. By laminating another electrode on the solid electrolyte layer formed as described above, an all-solid state secondary battery is formed. As long as the electrode sheet according to the embodiment of the present invention is used as at least one electrode, a typical electrode (a laminate including a collector and an active material layer) may be produced and used as another electrode. Preferred examples of the manufacturing method include a method of producing the electrode sheet according to the embodiment of the present invention as a positive electrode and a negative electrode and disposing a solid electrolyte layer between these electrodes.

The manufacturing method for an all-solid state secondary battery can be carried out in the atmosphere, but it is preferably carried out in an environment such as dry air (dew point: −20° C. or lower) or an inert gas (for example, argon gas, helium gas, or nitrogen gas).

A film of the solid electrolyte layer can be formed, for example, by preparing a solid electrolyte composition and coating and drying the solid electrolyte composition. The solid electrolyte composition is a composition containing an inorganic solid electrolyte, preferably a dispersion medium and a polymer binder, and appropriately the above-described additives, and it is preferably a slurry. The components contained in the solid electrolyte composition are as described above. The moisture content (also referred to as “water content”) in the solid electrolyte composition is not particularly limited and is preferably 500 ppm or lower, more preferably 200 ppm or lower, still more preferably 100 ppm or lower, and particularly preferably 50 ppm or lower. The moisture content refers to the amount of water (the mass proportion thereof to the solid electrolyte composition) in the solid electrolyte composition and specifically is determined as a value measured by Karl Fischer titration after filtering the solid electrolyte composition through a membrane filter having a pore size of 0.02 μm.

### Formation of Solid Electrolyte Layer (Film Formation)

The coating method of the solid electrolyte composition is not particularly limited, and the same method as the coating method of the above-described first electrode composition can be applied. In addition, the drying method (conditions) of the solid electrolyte composition is not particularly limited, and the above-described drying method (conditions) of the first electrode composition can be applied.

It is preferable that the solid electrolyte composition which has been subjected to film formation or the manufactured all-solid state secondary battery is pressurized. Examples of the pressurizing methods include a method using a hydraulic cylinder press machine. The pressurizing force is not particularly limited, but is, in general, preferably in a range of 50 to 1,500 MPa.

The above-described pressurization can also be carried out at the same time with the heating of the solid electrolyte composition. The heating temperature is not particularly limited, but is generally in a range of 30° C. to 300° C. The pressing can also be applied at a temperature higher than the glass transition temperature of the inorganic solid electrolyte. On the other hand, in a case where the inorganic solid electrolyte and the binder coexist, the pressing can also be carried out at a temperature higher than the glass transition temperature of a resin that forms the binder. The pressurization may be carried out in a state where the dispersion medium has been dried in advance or in a state where the dispersion medium remains. The pressing time may be a short time (for example, within several hours) at a high pressure or a long time (one day or longer) at an intermediate pressure. In a case where the all-solid state secondary battery is pressurized, a restraining tool (a screw fastening pressure or the like) can also be used in order to continuously apply an intermediate pressure.

The pressing pressure may be uniform or different with respect to a pressed portion. In this case, the pressing pressure can be changed according to the area or the layer thickness of the pressed portion. In addition, the same portion can be pressurized stepwise at different pressures. A pressing surface may be flat or roughened.

The solid electrolyte layer can also be formed by pressure-molding a solid mixture containing a component other than the dispersion medium.

### Initialization

It is preferable that the secondary battery manufactured as described above is subjected to initialization after the manufacturing or before the use. The initialization is not particularly limited, and for example, can be performed by carrying out initial charging and discharging in a state where the pressing pressure is increased and then releasing the pressure until it reaches a general working pressure of the secondary battery.

Since the electrode sheet according to the embodiment of the present invention has the above-described excellent adhesive force, for example, in a case where the electrode sheet according to the embodiment of the present invention is manufactured in an elongated line shape (even in a case of being wound during transportation) or in a case of being manufactured by an industrial manufacturing method such as a roll-to-roll method, the occurrence of the peeling between the collector and the active material layer and the collapse of the active material layer can be suppressed. In a case where such an electrode sheet is used, it is possible to manufacture an all-solid state secondary battery that exhibits excellent battery performance, with high productivity and a high yield (reproducibility).

### EXAMPLES

Hereinafter, the present invention will be described in more detail based on Examples, but the present invention is not limited thereto be interpreted. “Parts” and “%” that represent compositions in the following Examples are in terms of mass unless otherwise specified. In the present invention, “room temperature” means 25° C.

### 1. Synthesis and Preparation of Polymer

### [Synthesis Example S-1] Synthesis of Acrylic Polymer and Preparation of Acrylic Polymer Solution

24.0 g of methyl methacrylate (manufactured by FUJIFILM Wako Pure Chemical Corporation), 96.0 g of butyl acrylate (manufactured by FUJIFILM Wako Pure Chemical Corporation), and 480.0 g of toluene were added to a 1,000 mL three-neck flask equipped with a reflux condenser and a gas introduction cock, the mixture was subjected to nitrogen purging twice, 2.4 g of a polymerization initiator V-65 (product name, manufactured by FUJIFILM Wako Pure Chemical Corporation) was added thereto, the mixture was further subjected to nitrogen purging twice, and the mixture was heated in a nitrogen stream at 70° C. for 3 hours. The heating was continued until the disappearance of the peak derived from the residual monomer was confirmed by nuclear magnetic resonance analysis (NMR) to obtain poly (methyl methacrylate-co-butyl acrylate) as an acrylic polymer (mass average molecular weight: 34,000).

Thereafter, the mixture was cooled to room temperature and diluted with toluene until the concentration of solid substances was 10% to obtain an acrylic polymer solution.

### [Synthesis Example S-2] Synthesis of Acrylic Polymer Lx and Preparation of Dispersion Liquid of Acrylic Latex

A dispersion liquid of an acrylic polymer Lx (mass average molecular weight: 89,000) was obtained according to <Synthesis example of binder particles (D)> described in paragraph 0131 of WO2019/074076A. The particle diameter of the acrylic polymer Lx was 200 nm.

A binder consisting of the following polymer was used as the polymer binder.
Hydrogenated SBS: DYNARON 1321P (product name, manufactured by JSR Corporation)
SIBS: SIBSTAR 103T (product name, manufactured by Kaneka Corporation)
Acrylic rubber: TRISECT XB-A90 (product name, manufactured by Aron Kasei Co., Ltd.)
Fluororubber: DIEL G-704 (product name, a vinylidene fluoride/hexafluoropropylene copolymer, manufactured by Daikin Industries, Ltd.)
Hydrogenated SEBS: heptane solution (solid content: 10% by mass) of SEPTON 8004 (product name, manufactured by Kuraray Co., Ltd.)

### 2. Synthesis of Sulfide-Based Inorganic Solid Electrolyte

### Synthesis Example A

A sulfide-based inorganic solid electrolyte was synthesized with reference to non-patent documents of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box in an argon atmosphere (dew point: −70° C.), lithium sulfide (Li₂S, manufactured by Sigma-Aldrich Co., LLC, purity: >99.98%) (2.42 g) and diphosphorus pentasulfide (P₂S₅, manufactured by Sigma-Aldrich Co., LLC, purity: >99%) (3.90 g) each were weighed, put into an agate mortar, and mixed using an agate pestle for five minutes. The mixing ratio between Li₂S and P₂S₅ (Li₂S: P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). The particle diameter of the Li—P—S-based glass was 15 μm.

### 3. Preparation of First Electrode Composition

### Preparation of first electrode composition 1-1

3 g of hydrogenated styrene butadiene rubber (DYNARON 1321P: product name), and 100 g of dehydrated toluene were added to a planetary mixer (manufactured by TK High Viscosity Co., Ltd.), and the mixture was stirred and dissolved at room temperature at a rotation speed of 10 rpm for 1 hour to prepare a first electrode composition 1-1 (solid content concentration: 2.9% by mass).

### Preparation of First Electrode Compositions 1-2 to 1-6

Each of first electrode compositions 1-2 to 1-6 was prepared in the same manner as in the preparation of the first electrode composition 1-1, except that in the preparation of the first electrode composition 1-1, a binder consisting of a polymer shown in the column of “Polymer binder (C)” in Table 1-1 was used instead of the binder consisting of hydrogenated styrene butadiene rubber, and the sulfide-based inorganic solid electrolyte (LPS) was contained in a mass proportion of the content shown in Table 1-1, as necessary.

### Preparation of First Electrode Composition 1-7

A first electrode composition 1-7 (solid content concentration: 60% by mass) was prepared in the same manner as in the preparation of the first electrode composition 1-1, except that in the preparation of the first electrode composition 1-1, a binder consisting of hydrogenated styrene butadiene rubber, the sulfide-based inorganic solid electrolyte (LPS) synthesized in Synthesis Example A, lithium nickel manganese cobalt oxide (NMC), and dehydrated toluene were stirred and mixed at a mass proportion of the content shown in Table 1-1.

### 4. Preparation of Second Electrode Composition

### Preparation of Second Electrode Composition 2-1

70 g of lithium nickel manganese cobalt oxide (NMC), 26 g of the sulfide-based inorganic solid electrolyte (LPS) synthesized in Synthesis Example A, 20 g of a heptane solution (solid content: 10% by mass) of a hydrogenated styrene-based thermoplastic elastomer (SEPTON 8004: product name), 2 g of acetylene black, and 150 g of heptane were added to a planetary mixer, and the mixture was stirred at room temperature at a rotation speed of 50 rpm for 1 hour to prepare a second electrode composition 2-1 (solid content concentration: 60% by mass).

### Preparation of Second Electrode Compositions 2-2 to 2-12

Each of second electrode compositions 2-2 to 2-12 was prepared in the same manner as in the preparation of the second electrode composition 2-1, except that in the preparation of the second electrode composition 2-1, the kind or content of each component was changed to be the composition shown in Table 1-2.

In the first electrode composition and the second electrode composition, all the polymer binders (C) were dissolved in a dispersion medium (toluene or heptane) except for a binder consisting of an acrylic polymer Lx.

### 5. Production of Positive Electrode Sheet

### Production of Positive Electrode Sheet PK-1

The first electrode composition 1-1 prepared above was coated onto an aluminum collector (thickness: 20 μm) using a Baker type applicator (product name: SA-201, manufactured by Tester Sangyo Co., Ltd.), heated at 100° C. for 1 hour, and further dried at 120° C. for 1 hour to form a first electrode composition layer 1-1.

Next, the second electrode composition 2-1 prepared above was coated onto the surface of the first electrode composition layer 1-1 using the Baker type applicator, and immediately after the completion of the coating (within 90 seconds), the composition was heated at 100° C. for 1 hour and further dried at 140° C. for 1 hour to form a second electrode composition layer 2-1.

Next, the formed electrode composition layer was pressurized (20 MPa, 1 minute) while being heated (120° C.) using a heat press machine to produce a positive electrode sheet PK-1 having a laminated structure of the second electrode composition layer 2-1, the first electrode composition layer 1-1, and the aluminum collector. In the positive electrode sheet PK-1, the total layer thickness L of the active material layer (the first electrode composition layer 1-1 and the second electrode composition layer 2-1) is as shown in the column of “Layer thickness L of active material layer” in Table 1-3.

### Production of Positive Electrode Sheets PK-2 to PK-21

Each of positive electrode sheets PK-2 to PK-21 was produced in the same manner as in the production of the positive electrode sheet PK-1, except that, in the production of the positive electrode sheet PK-1, the first electrode composition and the second electrode composition were changed to the respective compositions shown in Table 1-1 and Table 1-2, the drying temperature immediately after the completion of the coating (also referred to as “immediately after coating”) of the second electrode composition (denoted as “Drying temperature immediately after coating” in Table 1-2) was changed to the temperature shown in Table 1-2, and further, as necessary, the coating amount of the first electrode composition layer was changed or the layer thickness L of the active material layer was changed to the value shown in Table 1-3.

### Production of Positive Electrode Sheets PKc21 to PKc23

Each of positive electrode sheets PKc21 to PKc23 was produced in the same manner as in the production of the positive electrode sheet PK-1, except that in the production of the positive electrode sheet PK-1, the first electrode composition and the second electrode composition were changed to the respective compositions shown in Table 1-1 and Table 1-2, the drying temperature immediately after the coating of the second electrode composition was changed to the temperature shown in Table 1-2, and the coating amount of the first electrode composition layer was changed or the layer thickness L of the active material layer was changed to the value shown in Table 1-3.

### 6. Production of Negative Electrode Sheet

### Production of Negative Electrode Sheets NK-1 and NK-2

Negative electrode sheets NK-1 and NK-2 were produced in the same manner as in the production of the positive electrode sheet PK-1, except that in the production of the positive electrode sheet PK-1, a copper collector (thickness: 20 μm) was used instead of the aluminum collector, the second electrode composition 2-1 was changed to the second electrode composition 2-8, the drying temperature immediately after the coating of the second electrode composition was changed to the temperature shown in Table 1-2, the coating amount of the first electrode composition layer was changed, and the layer thickness L of the active material layer was changed to the value shown in Table 1-3.

### Production of Negative Electrode Sheet NKc21

A negative electrode sheet NKc21 was produced in the same manner as in the production of the negative electrode sheet NK-1, except that in the production of the negative electrode sheet NK-1, the first electrode composition 1-1 and the second electrode composition 2-1 were changed to the first electrode composition 1-5 and the second electrode composition 2-11, respectively, the coating amount of the first electrode composition layer was changed, and the layer thickness L of the active material layer was changed to the value shown in Table 1-3.

### Calculation of S1

Cross sections of the produced electrode sheets (the positive electrode sheet and the negative electrode sheet) perpendicular to the longitudinal direction were processed using a Cross Section Polisher device (model number: IB-09010CP, manufactured by JEOL Ltd.), and five randomly selected visual fields of the polished cross sections were imaged with a scanning electron microscope (SEM) at a magnification of 3,000 times.

In the image of each visual field, the surface of the collector and the surface of the active material layer were specified as follows, and the total layer thickness L of the active material layer was calculated. Next, the active material layer was divided into 100 equal parts in the thickness direction, and a virtual line (interface between the first virtual divided active material layer 23-L1 and the second virtual divided active material layer 23-L2) for dividing the first virtual divided active material layer 23-L1 adjacent to the surface of the collector was determined.

The surface of the collector (the interface between the collector and the first virtual divided active material layer 23-L1) was determined by specifying at intervals of 1 μm (10 measurement points spaced apart from each other) in a region having a width of 10 μm in a width direction to be extracted, and connecting the measurement points adjacent to each other with a straight line to draw a surface virtual line. In addition, the interface between the first virtual divided active material layer 23-L1 and the second virtual divided active material layer 23-L2 was determined by specifying movement points by moving the interface (the specified 10 measurement points) of the collector and the first virtual divided active material layer 23-L1 obtained as described above in parallel from each interface at the measurement points in the thickness direction of the active material layer by a distance of 1/100 of the thickness, connecting adjacent movement points with a straight line to draw an interface virtual line. The layer thickness of the active material layer at each measurement point was defined as a thickness from the surface virtual line to the surface of the active material layer, and the arithmetic mean value of the 10 measurement points was defined as the total layer thickness L of the active material layer.

Next, as described above, in the image of each visual field, a rectangular region including the collector, the first virtual divided active material layer 23-L1, and the second virtual divided active material layer 23-L2 in the thickness direction and the width direction of 10 μm was extracted (selected), and for the first virtual divided active material layer 23-L1 (a region partitioned by the both end edges in the width direction of 10 μm, the surface virtual line, and the interface virtual line), an area a1 occupied by the material containing a carbon atom, an area a2 occupied by the material not containing a carbon atom, and an area a3 occupied by a void were ternarized by image processing software (ImageJ). Here, the area a1 occupied by the material containing a carbon atom, the area a2 occupied by the material not containing a carbon atom, and the area a3 occupied by a void were distinguished by element analysis by energy dispersive X-ray spectroscopy (SEM-EDX) using a scanning electron microscope.

Using the a1 and a2 obtained in this way, the area ratio of a1 with respect to the entire area of the first virtual divided active material layer 23-L1 was calculated from the expression: a1/(a1+a2). The values obtained from the five visual fields were arithmetically averaged and denoted as S1. The results are shown in Table 1-3.

### Calculation of S100

In each image of the five visual fields obtained in <Calculation of S1>described above, after determining the interface virtual line that divides the first virtual divided active material layer 23-L1, a rectangular region including the entire active material layer (the first virtual divided active material layer 23-L1 to the one hundredth virtual divided active material layer 23-L100) in the thickness direction and the width direction of 10 μm was extracted. S100 was calculated in the same manner as in <Calculation of S1>described above, except that the image processing was performed on the region (a region partitioned by the both end edges in the width direction of 10 μm, the interface virtual line, and the surface of the active material layer) from the second virtual divided active material layer 23-L2 to the one hundredth virtual divided active material layer 23-L100 in the rectangular region. The results are shown in Table 1-3.

### Calculation of S1/S100

In each electrode sheet, S1/S100 was calculated using S1 (average value) and S100 (average value) calculated as described above. The results are shown in Table 1-3.

### Calculation of (S1/S100)/L

S1/S100 (average value) calculated as described above was divided by the total layer thickness L (average value) of the active material layer obtained in <Calculation of S1>to calculate (S1/S100)/L. The results are shown in Table 1-3.

### Calculation of Layer Thickness Ratio [T_{C1}/T_{L1}]

The layer thicknesses of the first virtual divided active material layer 23-L1 at the measurement points obtained in <Calculation of S1>described above were arithmetically averaged to calculate a layer thickness T_{L1} of the first virtual divided active material layer 23-L1.

In addition, in the active material layer, the layer thickness T_{C1} of the layer in which the first electrode composition was formed into a film was calculated by determining the interface between the first electrode composition layer and the second electrode composition layer at the measurement point of the first virtual divided active material layer 23-L1 obtained in <Calculation of S1>described above. In the SEM image, it is possible to confirm and specify a partial region (a granular or a layer-shaped cross-sectional region) consisting of a material containing a carbon atom present (located) on the surface of the collector, and the partial region is used as a layer obtained by forming a film of the first electrode composition (the same applies in a case where a first electrode composition containing a material that does not correspond to a material containing a carbon atom, such as an active material or an inorganic solid electrolyte, is used). The interface between the first electrode composition layer and the second electrode composition layer was determined by connecting the end points (apexes) of partial regions (cross-sectional regions) in which a material containing a carbon atom was present in a continuous manner from the surface of the collector in the film thickness direction at intervals of 1 μm (10 measurement points spaced apart from each other) in a region having a width of 10 μm in the width direction in each SEM image. The layer thickness T_{C1} was obtained by measuring the thickness (distance) from the collector surface to the end point at each of the above-described 10 measurement points and calculating the arithmetic mean value thereof.

The calculated layer thickness T_{C1} was divided by the obtained layer thickness T_{L1} to calculate a layer thickness ratio [T_{C1}/T_{L1}]. The results are shown in Table 1-3.

### Content of Each Component in Active Material Layer

The content of each component in the entire active material layer of each produced electrode sheet is strictly different from the content in the solid content of the second electrode composition, but can be regarded as the same as the content in the solid content of the second electrode composition since the coating amount of the first electrode composition is extremely small.

### Evaluation of Rate of Change in Electron Conductivity Before and After Vibration Test

### Measurement of Electron Conductivity Before Vibration Test

Two disk-shaped sheets having a diameter of 10 mm were punched out from each of the produced electrode sheets, the active material layers of the disk-shaped sheets were laminated to face (contact) each other, and the laminate was pressurized by applying a pressure of 350 MPa in the lamination direction to produce a measurement sample. The measurement sample was restrained with a 10 mm (diameter) round bar made of STAINLESS STEEL in a thickness direction at a pressure of 50 MPa to obtain a measurement cell.

A voltage of 5 mV was applied to the produced measurement cell in a constant-temperature tank at 30° C., and the direct current resistance was measured to calculate the electron conductivity σ1 of the electrode sheet before the vibration test.

### Measurement of Electron Conductivity After Vibration Test

On the other hand, the measurement cell produced from the same electrode sheet as described above was set in a vibration tester (model number: EM2305, manufactured by IMV Corporation) such that the electrode lamination surface (the lamination surface between the active material layers) and the vibration direction were parallel to each other, and a vibration test was carried out under conditions in accordance with Japanese Industrial Standards (JIS) D 1601, which is a vibration test method for automobile parts. That is, in “5.3 Vibration endurance test” of the above standard, a vibration test was performed under the conditions of stage 30, a vibration frequency of 33 Hz, and a vibration acceleration of 30 m/s².

A voltage of 5 mV was applied to the measurement cell after the end of the vibration test in a constant-temperature tank at 30° C., and the direct current resistance was measured to calculate the electron conductivity σ2.

### Calculation of Rate of Change in Electron Conductivity

Using the electron conductivities σ1 and σ2 obtained as described above, a rate of change (%) in electron conductivities before and after the vibration test was calculated from the expression: (1−σ2/σ1)×100, and the adhesive force of the electrode sheet due to the vibration test was evaluated based on which of the following evaluation standards the electrode sheet was included in.

In the present test, the smaller the rate of change in the electron conductivity, the higher the particle adhesive force, the interlayer adhesive force, and the interface adhesive force, and the adhesion state can be maintained even in a case of being subjected to repeated vibration. A case where the evaluation standard is “D” or higher is regarded as the pass level of the present invention. The results are shown in the column of “Rate of change in electron conductivity” in Table 1-3.
A: rate of change is less than 15%
B: rate of change is 15% or more and less than 30%
C: rate of change is 30% or more and less than 40%
D: rate of change is 40% or more and less than 50%.
E: rate of change is 50% or more.

TABLE 1

| | | | First electrode composition | | | | | | | | |
|---|---|---|---|---|---|---|---|---|---|---|---|
| | | | | | | | | | | Conductive auxiliary | |
| Electrode sheet | | | | Inorganic solid electrolyte (A) | | Active material (B) | | Polymer binder (C) | | agent (D) | |
| | No. | Collector | No. | | Content | | Content | | Content | | Content |
| Positive | PK-1 | Al | 1-1 | LPS | 0 | NMC | 0 | Hydrogenated SBS | 1 | AB | 0 |
| electrode | PK-2 | Al | 1-1 | LPS | 0 | NMC | 0 | Hydrogenated SBS | 1 | AB | 0 |
| sheet | PK-3 | Al | 1-1 | LPS | 0 | NMC | 0 | Hydrogenated SBS | 1 | AB | 0 |
| | PK-4 | Al | 1-1 | LPS | 0 | NMC | 0 | Hydrogenated SBS | 1 | AB | 0 |
| | PK-5 | Al | 1-1 | LPS | 0 | NMC | 0 | Hydrogenated SBS | 1 | AB | 0 |
| | PK-6 | Al | 1-1 | LPS | 0 | NMC | 0 | Hydrogenated SBS | 1 | AB | 0 |
| | PK-7 | Al | 1-2 | LPS | 0 | NMC | 0 | Acrylic Lx | 1 | AB | 0 |
| | PK-8 | Al | 1-1 | LPS | 0 | NMC | 0 | Hydrogenated SBS | 1 | AB | 0 |
| | PK-9 | Al | 1-1 | LPS | 0 | NMC | 0 | Hydrogenated SBS | 1 | AB | 0 |
| | PK-10 | Al | 1-1 | LPS | 0 | NMC | 0 | Hydrogenated SBS | 1 | AB | 0 |
| | PK-11 | Al | 1-1 | LPS | 0 | NMC | 0 | Hydrogenated SBS | 1 | AB | 0 |
| | PK-12 | Al | 1-7 | LPS | 2.6 | NMC | 7 | Hydrogenated SBS | 0.66 | AB | 0 |
| | PK-13 | Al | 1-1 | LPS | 0 | NMC | 0 | Hydrogenated SBS | 1 | AB | 0 |
| | PK-14 | Al | 1-2 | LPS | 0 | NMC | 0 | Acrylic Lx | 1 | AB | 0 |
| | PK-15 | Al | 1-1 | LPS | 0 | NMC | 0 | Hydrogenated SBS | 1 | AB | 0 |
| | PK-16 | Al | 1-7 | LPS | 2.6 | NMC | 7 | Hydrogenated SBS | 0.66 | AB | 0 |
| | PK-17 | Al | 1-7 | LPS | 2.6 | NMC | 7 | Hydrogenated SBS | 0.66 | AB | 0 |
| | PK-18 | Al | 1-3 | LPS | 1 | NMC | 0 | SIBS | 1 | AB | 0 |
| | PK-19 | Al | 1-4 | LPS | 1 | NMC | 0 | Acrylic rubber | 1 | AB | 0 |
| | PK-20 | Al | 1-1 | LPS | 0 | NMC | 0 | Hydrogenated SBS | 1 | AB | 0 |
| | PK-21 | Al | 1-1 | LPS | 0 | NMC | 0 | Hydrogenated SBS | 1 | AB | 0 |
| Negative | NK-1 | Cu | 1-1 | LPS | 0 | NMC | 0 | Hydrogenated SBS | 1 | AB | 0 |
| electrode | NK-2 | Cu | 1-1 | LPS | 0 | NMC | 0 | Hydrogenated SBS | 1 | AB | 0 |
| sheet | | | | | | | | | | | |
| Positive | PKc21 | Al | 1-5 | LPS | 0 | NMC | 0 | Fluororubber | 1 | AB | 0 |
| electrode | PKc22 | Al | 1-6 | LPS | 0 | NMC | 0 | Acrylic rubber | 1 | AB | 0 |
| sheet | PKc23 | Al | 1-1 | LPS | 0 | NMC | 0 | Hydrogenated SBS | 1 | AB | 0 |
| Negative | NKc21 | Cu | 1-5 | LPS | 0 | NMC | 0 | Fluororubber | 1 | AB | 0 |
| electrode | | | | | | | | | | | |
| sheet | | | | | | | | | | | |

| | | Second electrode composition | | | | | | | | | |
|---|---|---|---|---|---|---|---|---|---|---|---|
| | | | | | | | | | | | Drying |
| | | | Inorganic solid | | | | | | Conductive auxiliary | | temperature |
| Electrode sheet | | | electrolyte (A) | | Active material (B) | | Polymer binder (C) | | agent (D) | | immediately |
| | No. | No. | | Content | | Content | | Content | | Content | after coating |
| Postive | PK-1 | 2-1 | LPS | 2.6 | NMC | 7 | Hydrogenerated SEBS | 0.2 | AB | 0.2 | 100 |
| electrode | PK-2 | 2-1 | LPS | 2.6 | NMC | 7 | Hydrogenerated SEBS | 0.2 | AB | 0.2 | 80 |
| sheet | PK-3 | 2-1 | LPS | 2.6 | NMC | 7 | Hydrogenerated SEBS | 0.2 | AB | 0.2 | 110 |
| | PK-4 | 2-1 | LPS | 2.6 | NMC | 7 | Hydrogenerated SEBS | 0.2 | AB | 0.2 | 120 |
| | PK-5 | 2-1 | LPS | 2.6 | NMC | 7 | Hydrogenerated SEBS | 0.2 | AB | 0.2 | 120 |
| | PK-6 | 2-2 | LPS | 2.6 | NMC | 7 | Acryl | 0.2 | AB | 0.2 | 110 |
| | PK-7 | 2-2 | LPS | 2.6 | NMC | 7 | Acryl | 0.2 | AB | 0.2 | 110 |
| | PK-8 | 2-1 | LPS | 2.6 | NMC | 7 | Hydrogenerated SEBS | 0.2 | AB | 0.2 | 110 |
| | PK-9 | 2-1 | LPS | 2.6 | NMC | 7 | Hydrogenerated SEBS | 0.2 | AB | 0.2 | 110 |
| | PK-10 | 2-3 | LPS | 2.6 | NMC | 7 | Hydrogenerated SEBS | 0.01 | AB | 0.1 | 110 |
| | PK-11 | 2-4 | LPS | 2.6 | NMC | 7 | Hydrogenerated SEBS | 0.2 | AB | 2 | 110 |
| | PK-12 | 2-1 | LPS | 2.6 | NMC | 7 | Hydrogenerated SEBS | 0.2 | AB | 0.2 | 110 |
| | PK-13 | 2-5 | LPS | 2.6 | NMC | 7 | Hydrogenerated SEBS | 0.31 | AB | 0.2 | 110 |
| | PK-14 | 2-6 | LPS | 2.6 | NMC | 7 | Hydrogenerated SEBS | 0.01 | AB | 0.01 | 110 |
| | PK-15 | 2-6 | LPS | 2.6 | NMC | 7 | Hydrogenerated SEBS | 0.01 | AB | 0.01 | 110 |
| | PK-16 | 2-6 | LPS | 2.6 | NMC | 7 | Hydrogenerated SEBS | 0.01 | AB | 0.01 | 110 |
| | PK-17 | 2-7 | LPS | 2.6 | NMC | 7 | Hydrogenerated SEBS | 0.005 | AB | 0.01 | 110 |
| | PK-18 | 2-2 | LPS | 2.6 | NMC | 7 | Acryl | 0.2 | AB | 0.2 | 110 |
| | PK-19 | 2-2 | LPS | 2.6 | NMC | 7 | Acryl | 0.2 | AB | 0.2 | 110 |
| | PK-20 | 2-1 | LPS | 2.6 | NMC | 7 | Hydrogenerated SEBS | 0.2 | AB | 0.2 | 110 |
| | PK-21 | 2-12 | LPS | 2.6 | NMC | 7 | Hydrogenerated SBS | 0.2 | AB | 0.2 | 110 |
| Negative | NK-1 | 2-8 | LPS | 4.8 | Si | 3.5 | Hydrogenerated SEBS | 0.2 | AB | 1.5 | 110 |
| electrode | NK-2 | 2-8 | LPS | 4.8 | Si | 3.5 | Hydrogenerated SEBS | 0.2 | AB | 1.5 | 110 |
| sheet | | | | | | | | | | | |
| Positive | PKc21 | 2-9 | LPS | 2.6 | NMC | 7 | Fluororubber | 0.2 | AB | 0.2 | 110 |
| electrode | PKc22 | 2-10 | LPS | 2.6 | NMC | 7 | Acryl | 0.2 | AB | 2 | 110 |
| sheet | PKc33 | 2-1 | LPS | 2.6 | NMC | 7 | Hydrogenerated SEBS | 0.2 | AB | 0.2 | 110 |
| Negative | NKc21 | 2-11 | LPS | 4.8 | Si | 3.5 | Fluororubber | 0.2 | AB | 1.5 | 110 |
| electrode | | | | | | | | | | | |
| sheet | | | | | | | | | | | |

| | | Active material layer | | | | | | | | |
|---|---|---|---|---|---|---|---|---|---|---|
| | | First electrode | | | | | | | | |
| | | composition layer | | | | | | | | |
| | | | Layer | Layer thickness | | | | (S1/ | Rate of change | |
| Electrode sheet | | Layer | thickness | L of active | | | S1/ | S100)/ | in electron | |
| | No. | thickness T [symbol] | ratio T [symbol] /T [symbol] | material layer | S1 | S100 | S100 | L1 | conductivity | Reference |
| Pasitive | PK-1 | 0.2 | 0.40 | 50 | 0.46 | 0.10 | 4.6 | 0.092 | B | Prevent Invention |
| electrode | PK-2 | 0.4 | 0.40 | 100 | 0.46 | 0.10 | 4.6 | 0.046 | A | Prevent Invention |
| sheet | PK-3 | 0.8 | 0.53 | 150 | 0.58 | 0.10 | 5.8 | 0.039 | A | Prevent Invention |
| | PK-4 | 0.9 | 0.45 | 200 | 0.51 | 0.10 | 5.1 | 0.025 | A | Prevent Invention |
| | PK-5 | 1.0 | 0.33 | 300 | 0.40 | 0.10 | 4.0 | 0.013 | B | Prevent Invention |
| | PK-6 | 0.8 | 0.53 | 150 | 0.58 | 0.10 | 3.8 | 0.039 | A | Prevent Invention |
| | PK-7 | 0.7 | 0.47 | 150 | 0.52 | 0.10 | 5.2 | 0.035 | D | Prevent Invention |
| | PK-8 | 0.8 | 0.16 | 500 | 0.24 | 0.10 | 2.4 | 0.005 | D | Prevent Invention |
| | PK-9 | 0.2 | 0.50 | 40 | 0.55 | 0.10 | 5.5 | 0.138 | D | Prevent Invention |
| | PK-10 | 0.2 | 0.13 | 150 | 0.15 | 0.02 | 7.0 | 0.047 | C | Prevent Invention |
| | PK-11 | 0.3 | 0.20 | 150 | 0.45 | 0.31 | 1.5 | 0.009 | D | Prevent Invention |
| | PK-12 | 0.8 | 0.53 | 150 | 0.15 | 0.10 | 1.5 | 0.010 | C | Prevent Invention |
| | PK-13 | 0.8 | 0.53 | 150 | 0.59 | 0.13 | 4.5 | 0.030 | C | Prevent Invention |
| | PK-14 | 0.8 | 0.53 | 150 | 0.54 | 0.006 | 97.0 | 0.647 | D | Prevent Invention |
| | PK-15 | 0.8 | 0.27 | 300 | 0.27 | 0.006 | 49.0 | 0.163 | D | Prevent Invention |
| | PK-16 | 0.8 | 0.53 | 150 | 0.11 | 0.006 | 19.8 | 0.132 | D | Prevent Invention |
| | PK-17 | 1.0 | 0.67 | 150 | 0.13 | 0.004 | 36.5 | 0.243 | D | Prevent Invention |
| | PK-18 | 0.8 | 0.53 | 150 | 0.58 | 0.10 | 5.8 | 0.039 | A | Prevent Invention |
| | PK-19 | 0.8 | 0.53 | 150 | 0.58 | 0.10 | 5.8 | 0.039 | A | Prevent Invention |
| | PK-20 | 0.4 | 0.27 | 150 | 0.34 | 0.10 | 3.4 | 0.023 | B | Prevent Invention |
| | PK-21 | 0.8 | 0.53 | 150 | 0.58 | 0.10 | 5.8 | 0.039 | C | Prevent Invention |
| Negative | NK-1 | 1.0 | 0.40 | 250 | 0.51 | 0.19 | 2.7 | 0.011 | C | Prevent Invention |
| electrode | NK-1 | 1.2 | 0.48 | 250 | 0.58 | 0.19 | 3.1 | 0.012 | B | Prevent Invention |
| sheet | | | | | | | | | | |
| Positive | PKc21 | 10 | 12.5 | 80 | 1.00 | 0.10 | 10.0 | 0.125 | E | Comparative Example |
| Electrode | PKc22 | 0.1 | 0.06 | 165 | 0.35 | 0.31 | 1.1 | 0.007 | E | Comparative Example |
| sheet | PKc23 | 0.5 | 0.71 | 70 | 0.74 | 0.10 | 7.4 | 0.106 | E | Comparative Example |
| Negative | NKc21 | 10 | 20.0 | 50 | 1.00 | 0.19 | 5.4 | 0.107 | E | Comparative Example |
| electrode | | | | | | | | | | |
| sheet | | | | | | | | | | |

[symbol]

indicates data missing or illegible when filed

In Table 1, “Content” indicates a mass ratio of the content of each component in each electrode composition. The unit of “Drying temperature immediately after coating” in Table 1-2 is “° C.”, and the units of “Layer thickness T_{C1}” and “Layer thickness L” in Table 1-3 are both “μm”, but the units are omitted in each table.

The symbols in Table 1 are as follows.
Al: aluminum collector
Cu: copper collector
Acryl: acrylic polymer synthesized in Synthesis Example S-1
Acrylic Lx: acrylic latex synthesized in Synthesis Example S-2
LPS: sulfide-based inorganic solid electrolyte synthesized in Synthesis Example A
Si: silicon
NMC: lithium nickel manganese cobalt oxide
AB: acetylene black

### 7. Manufacture of All-Solid State Secondary Battery

### Production of Solid Electrolyte Sheet for All-Solid State Secondary Battery

60 g of zirconia beads having a diameter of 5 mm were put into a 45 mL container made of zirconia (manufactured by FRITSCH), and 8.4 g of the LPS synthesized in the above Synthesis Example A, 0.6 g (in terms of solid content mass) of KYNAR FLEX 2500-20 (product name, PVDF-HFP: polyvinylidene fluoride-hexafluoropropylene copolymer, manufactured by Arkema S.A.), and 11 g of butyl butyrate as the dispersion medium were put into the above container. Then, this container was set in a planetary ball mill P-7 (product name, manufactured by FRITSCH). Mixing was carried out at a temperature of 25° C. and a rotation speed of 150 rpm for 10 minutes to prepare an inorganic solid electrolyte-containing composition (slurry).

Using a Baker type applicator (product name: SA-201, manufactured by Tester Sangyo Co., Ltd.), the inorganic solid electrolyte-containing composition obtained as described above was coated on an aluminum foil having a thickness of 20 μm, and heating was carried out at 80° C. for 2 hours to dry (remove the dispersion medium) the inorganic solid electrolyte-containing composition. Then, using a heat press machine, the inorganic solid electrolyte-containing composition dried at a temperature of 120° C. and a pressure of 40 MPa for 10 seconds and was heated and pressurized to produce a solid electrolyte sheet for an all-solid state secondary battery. The layer thickness of the solid electrolyte layer was 50 μm.

### Production of Positive Electrode Sheets PK-1 to PK-19 and PKc21 to PKc23, Which Comprises Solid Electrolyte Layer

The solid electrolyte sheet for an all-solid state secondary battery produced by the above-described method was laminated on the positive electrode active material layer of each of the positive electrode sheets shown in the column of “Positive electrode sheet” in Table 2 so that the solid electrolyte layer was in contact with the positive electrode active material layer, transferred (laminated) by being pressurized at 50 MPa using a press machine in an environment of 25° C., and then pressurized at 600 MPa in an environment of 25° C. to produce each of positive electrode sheets PK-1 to PK-19 and PKc21 to PKc23 comprising a solid electrolyte layer having a layer thickness of 20 μm.

### Manufacture of all-solid state secondary battery CK-1

Next, an all-solid state secondary battery CK-1 having the layer configuration shown in FIG. 2 was manufactured.

The positive electrode sheet PK-1 (the aluminum foil of the solid electrolyte sheet for an all-solid state secondary battery was peeled off) comprising the solid electrolyte layer obtained as described above was cut out into a disk shape having a diameter of 14.5 mm and placed in a stainless 2032-type coin case into which a spacer and a washer are incorporated. Next, the negative electrode sheet NK-1 cut out from the negative electrode sheet NK-1 into a disk shape having a diameter of 15 mm was disposed to be laminated on the solid electrolyte layer so that the negative electrode active material layer was in contact with the solid electrolyte layer. A stainless steel foil was further laminated thereon to form a laminate for an all-solid state secondary battery (a laminate consisting of an aluminum foil-a positive electrode active material layer—a solid electrolyte layer—a negative electrode active material layer—a copper foil—a stainless steel foil). Then, the 2032-type coin case was crimped to manufacture an all-solid state secondary battery CK-1.

### Manufacture of all-solid state secondary batteries CK-2 to CK-21 and CKc-1 to CKc-3

Each of all-solid state secondary batteries CK-2 to CK-21 and CKc-1 to CKc-3 was manufactured in the same manner as in the manufacturing of the all-solid state secondary battery CK-1, except that, in the manufacturing of the all-solid state secondary battery CK-1, each of the electrode sheets shown in the column of “Positive electrode sheet” or the column of “Negative electrode sheet” in Table 2 was used instead of the positive electrode sheet PK-1 or the negative electrode sheet NK-1 comprising the solid electrolyte layer.

### Evaluation of Cycle Characteristics After Vibration Test

For each of the manufactured all-solid state secondary batteries, the cycle characteristics after the vibration test were evaluated using a charging and discharging evaluation device “TOSCAT-3000” (product name, manufactured by Toyo System Corporation).

Specifically, each of the all-solid state secondary batteries was charged at a current value of 0.2 mA until the battery voltage reached 4.2 V in an environment of 30° C. The all-solid state secondary battery after charging was set in a vibration tester (model number: EM2305, manufactured by IMV Corporation) such that the electrode lamination surface and the vibration direction were parallel to each other, and a vibration test was performed under conditions in accordance with JIS D 1601. That is, in “5.3 Vibration endurance test” of the above standard, a vibration test was performed under the conditions of stage 30, a vibration frequency of 33 Hz, and a vibration acceleration of 30 m/s².

Next, each of the all-solid state secondary batteries after the vibration test was charged at a current value of 0.2 mA until the battery voltage reached 4.2 V, and then discharged at a current value of 0.2 mA until the battery voltage reached 3.0 V. One charging and one discharging were defined as one cycle of charging and discharging. The charging and discharging cycle was repeated until the discharge capacity reached a discharge capacity of less than 80% of the discharge capacity in the third cycle. From the number of cycles in which the discharge capacity of 80% or more of the discharge capacity in the third cycle was maintained, the cycle characteristics were evaluated according to the following evaluation standards. In the evaluation standard, “D” or higher is the pass level of the present invention, and “C” or higher is a more excellent pass level of the present invention. The results are shown in Table 2.

### -Evaluation Standards-

AA: 60 times or more
A: 50 times or more and less than 60 times
B: 40 times or more and less than 50 times
C: 30 times or more and less than 40 times
D: 10 times or more and less than 30 times
E: less than 10 times

In a case where the electrodes were taken out from each of the manufactured all-solid state secondary batteries and S1, S100, S1/S100, and (S1/S100)/L were measured in the same manner as the electrode sheet, the results were substantially the same.

In addition, the all-solid state secondary batteries in Examples had excellent ion conductivity and electron conductivity.

TABLE 2

| All-solid | | Solid electrolyte layer | | | | |
|---|---|---|---|---|---|---|
| state | Positive | | Layer | Negative | | |
| secondary | electrode | | thickness | electrode | Cycle | |
| battery | sheet | | (μm) | sheet | characteristics | Reference |
| CK-1 | PK-1 | LPS | 20 | NK-1 | A | Present Invention |
| CK-2 | PK-2 | LPS | 20 | NK-1 | A | Present Invention |
| CK-3 | PK-3 | LPS | 20 | NK-1 | A | Present Invention |
| CK-4 | PK-4 | LPS | 20 | NK-1 | A | Present Invention |
| CK-5 | PK-5 | LPS | 20 | NK-1 | A | Present Invention |
| CK-6 | PK-6 | LPS | 20 | NK-1 | AA | Present Invention |
| CK-7 | PK-7 | LPS | 20 | NK-1 | C | Present Invention |
| CK-8 | PK-8 | LPS | 20 | NK-1 | C | Present Invention |
| CK-9 | PK-9 | LPS | 20 | NK-1 | C | Present Invention |
| CK-10 | PK-10 | LPS | 20 | NK-1 | B | Present Invention |
| CK-11 | PK-11 | LPS | 20 | NK-1 | C | Present Invention |
| CK-12 | PK-12 | LPS | 20 | NK-1 | B | Present Invention |
| CK-13 | PK-13 | LPS | 20 | NK-1 | B | Present Invention |
| CK-14 | PK-14 | LPS | 20 | NK-1 | C | Present Invention |
| CK-15 | PK-15 | LPS | 20 | NK-1 | C | Present Invention |
| CK-16 | PK-16 | LPS | 20 | NK-1 | C | Present Invention |
| CK-17 | PK-17 | LPS | 20 | NK-1 | C | Present Invention |
| CK-18 | PK-18 | LPS | 20 | NK-1 | A | Present Invention |
| CK-19 | PK-19 | LPS | 20 | NK-1 | A | Present Invention |
| CK-20 | PK-3 | LPS | 20 | NKc21 | D | Present Invention |
| CK-21 | PKc22 | LPS | 20 | NK-1 | D | Present Invention |
| CKc-1 | PKc21 | LPS | 20 | NKc21 | E | Comparative Example |
| CKc-2 | PKc22 | LPS | 20 | NKc21 | E | Comparative Example |
| CKc-3 | PKc23 | LPS | 20 | NKc21 | E | Comparative Example |

The following findings can be seen from the results of Table 1 and Table 2.

That is, in all of the electrode sheets of Comparative Examples in which the active material layer provided on the collector does not satisfy Expression (1) or Expression (2), the adhesive force was not sufficient, and in a case where the electrode sheet was repeatedly subjected to vibration, the adhesion state of the solid particles or the adhesion state with the collector was collapsed, and the electron conductivity was significantly deteriorated by the vibration test (Table 1). In all of the all-solid state secondary batteries of Comparative Examples, which incorporate these electrode sheets, the cycle characteristics are deteriorated (Table 2).

On the other hand, in all the electrode sheets of Examples in which the active material layer provided on the collector satisfies Expression (1) or Expression (2), the adhesive force is strong enough to maintain the adhesion state of the solid particles or the adhesion state with the collector even in a case where the electrode sheet is repeatedly subjected to vibration, and excellent electron conductivity can be maintained. All of the all-solid state secondary batteries of Examples, which incorporate these electrode sheets, can realize excellent cycle characteristics.

The present invention has been described with the embodiments thereof, any details of the description of the present invention are not limited unless specified otherwise, and it is obvious that the present invention is widely construed without departing from the gist and scope of the present invention described in the accompanying claims.

The present application claims priority based on JP2022-210759 filed in Japan on Dec. 27, 2022, and the content thereof is incorporated in the present specification by reference as a part of the description.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
21: electrode sheet
22: collector
23: active material layer
23-L1: first virtual divided active material layer
23-L2: second virtual divided active material layer
23-L99: ninety-ninth virtual divided active material layer
23-L100: one hundredth virtual divided active material layer
31: inorganic solid electrolyte (A)
32: active material (B)
33: void

What is claimed is:

1. An electrode sheet for an all-solid state secondary battery, comprising:
an active material layer on at least one surface of a collector,
wherein the active material layer has an inorganic solid electrolyte (A) having an ion conductivity of a metal belonging to Group 1 or Group 2 in the periodic table and an active material (B), and the active material layer satisfies Expression (1) and Expression (2),
$$\begin{matrix}1.4 < S 1 / S 100 , & Expression ( 1 ) \\ 0.05 < S 1 < 0 .60 , & Expression ( 2 )\end{matrix}$$
in the above expressions, S1 represents an area ratio of a total area of a material containing a carbon atom with respect to an entire area of a cross-sectional region having a layer thickness of 1% or less of the active material layer from the surface of the collector, and
S100 represents an area ratio of a total area of the material containing a carbon atom with respect to an entire area of a cross-sectional region having a layer thickness of more than 1% of the active material layer from the surface of the collector.

2. The electrode sheet for an all-solid state secondary battery according to claim 1,
wherein the active material layer satisfies Expression (4),
$$0.010 < ( S 1 / S 100 ) / L < 0.100 , \qquad Expression ( 4 )$$
in Expression (4), L represents a layer thickness of the active material layer, and S1 and S100 are as described above.

3. The electrode sheet for an all-solid state secondary battery according to claim 1,
wherein the active material layer contains a polymer binder (C) and a conductive auxiliary agent (D), and
the material containing a carbon atom contains the polymer binder (C) and the conductive auxiliary agent (D).

4. The electrode sheet for an all-solid state secondary battery according to claim 3,
wherein the polymer binder (C) includes two or more kinds of polymer binders.

5. The electrode sheet for an all-solid state secondary battery according to claim 4,
wherein at least one of the two or more kinds of polymer binders is a polymer binder consisting of a rubber-like polymer.

6. The electrode sheet for an all-solid state secondary battery according to claim 1,
wherein the active material layer satisfies Expression (3),
$$0.005 < S 100 < 0.30 , \qquad Expression ( 3 )$$
in Expression (3), S100 is as described above.

7. The electrode sheet for an all-solid state secondary battery according to claim 1,
wherein a rate of change in an electron conductivity 62 after the following vibration test with respect to an electron conductivity σ1 before the following vibration test: (1σ2/σ1)×100 is less than 50%, <vibration test>
two disk-shaped sheets having a diameter of 10 mm are punched out from the electrode sheet, the active material layers of the disk-shaped sheets are laminated to face each other, the laminate is pressurized by applying a pressure of 350 MPa in a lamination direction, and the laminate is restrained by a round bar made of STAINLESS STEEL having a diameter of 10 mm at 50 MPa in a thickness direction to produce a measurement cell,
this measurement cell is set in a vibration tester such that an electrode lamination surface and a vibration direction are parallel to each other, and a vibration test is performed under the conditions of stage 30, a vibration frequency of 33 Hz, and a vibration acceleration of 30 m/s² as conditions in accordance with Japanese Industrial Standards D 1601,
a voltage of 5 mV is applied to the measurement cell before and after the vibration test in a constant-temperature tank at 30° C. and a direct current resistance is measured to calculate each of the electron conductivity σ1 before the vibration test and the electron conductivity σ2 after the vibration test.

8. An all-solid state secondary battery comprising:
a positive electrode;
a negative electrode; and
a solid electrolyte layer between the positive electrode and the negative electrode,
wherein at least one of the positive electrode or the negative electrode is composed of the electrode sheet for an all-solid state secondary battery according to claim 1.
